(19) United States
(12) Patent Application Publication
(10) Pub. No.: US 2019/0130648 A1
(43) Pub. Date: May 2, 2019

(54) SYSTEMS AND METHODS FOR ENABLING DISPLAY OF VIRTUAL INFORMATION DURING MIXED REALITY EXPERIENCES

(71) Applicant: Tsunami VR, Inc., Del Mar, CA (US)

(72) Inventors: Anthony DUCA, Carlsbad, CA (US); David ROSS, San Diego, CA (US); Beth BREWER, Escondido, CA (US); Kyle PENDERGRASS, San Diego, CA (US)

(21) Appl. No.: 16/171,051

(22) Filed: Oct. 25, 2018

Related U.S. Application Data
(60) Provisional application No. 62/577,486, filed on Oct. 26, 2017.

(51) Int. Cl. G06T 19/00; G06T 13/40

(52) U.S. Cl. CPC G06T 19/006; G06T 2200/04; G06T 19/003; G06T 13/40

(57) ABSTRACT

Systems, methods, and computer readable media for displaying an augmented reality environment are disclosed. The method can include generating a geospatial map of a physical environment indicating a relative position of the one or more physical objects to a position of a first device of a first user, determining one or more candidate locations within the physical environment for projecting an avatar of a second user based on the geospatial map of the physical environment, and causing the first device to display the avatar of the second user at a selected candidate location of the one or more candidate locations.

### CROSS REFERENCE TO RELATED APPLICATIONS

This application claims priority to U.S. Provisional Patent Application Ser. No. 62/577,486, filed Oct. 26, 2017, entitled “SYSTEMS AND METHODS FOR ENABLING DISPLAY OF VIRTUAL INFORMATION DURING MIXED REALITY EXPERIENCES,” the contents of which are hereby incorporated by reference in their entirety.

### BACKGROUND

### Technical Field

This disclosure relates to different approaches for enabling display of virtual information during mixed reality experiences (e.g., virtual reality (VR), augmented reality (AR), and hybrid reality experiences).

### Related Art

AR is a field of computer applications that enables the combination of real world images and computer generated data or VR simulations. Many AR applications are concerned with the use of live video imagery that is digitally processed and augmented by the addition of computer generated or VR graphics. For instance, an AR user may wear goggles or other a head mounted display through which the user may see the real, physical world as well as computer-generated or VR images projected on top of physical world.

### SUMMARY

An aspect of the disclosure provides a method for displaying an augmented reality environment. The method can include generating a geospatial map of a physical environment indicating a relative position of the one or more physical objects to a position of a first device of a first user. The method can include storing virtual representations of the physical environment and the one or more physical objects to a memory. The method can include determining one or more candidate locations within the physical environment for projecting an avatar of a second user based on the geospatial map of the physical environment. The method can include causing the first device to display the avatar of the second user at a selected candidate location of the one or more candidate locations.

Another aspect of the disclosure provides a non-transitory computer-readable medium comprising instructions for displaying an augmented reality environment. When executed by one or more processors the instructions cause the one or more processors to generate a geospatial map of a physical environment indicating a relative position of the one or more physical objects to a position of a first device of a first user. The instructions further cause the one or more processors to store virtual representations of the physical environment and the one or more physical objects to a memory. The instructions further cause the one or more processors to determine one or more candidate locations within the physical environment for projecting an avatar of a second user based on the geospatial map of the physical environment. The instructions further cause the one or more processors to cause the first device to display the avatar of the second user at a selected candidate location of the one or more candidate locations.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a positioning system for enabling display of virtual information during mixed reality experiences;

FIG. 1B a functional block diagram of an embodiment of a positioning system for enabling display of virtual information during mixed reality experiences;

FIG. 2A through FIG. 2E are graphical representations of embodiments of processes for displaying virtual objects of a virtual environment using an AR device;

FIG. 3A and FIG. 3B are flowcharts of embodiments of processes for determining how to display virtual objects of a virtual environment using an AR device;

FIG. 4A and FIG. 4B are graphical representations of embodiments of processes for generating virtual objects that represent physical objects of a physical environment in view of an AR device, positioning the generated virtual objects in a virtual environment so the virtual objects can be viewed by a remote user of another device, and using the AR device to display an interaction between the remote user and the generated virtual objects.

FIG. 5 is a flowchart of a method for generating virtual objects that represent physical objects of a physical environment in view of an AR device, positioning the generated virtual objects in a virtual environment so the virtual objects can be viewed by a remote user of another device, and using the AR device to display an interaction between the remote user and the generated virtual objects.

FIG. 6 is a functional block diagram of an embodiment of a system for analyzing images of a physical environment to identify projection region(s) over which a virtual object can be displayed using an AR device, optionally requesting user action to enable a different projection region, and displaying the virtual object in a selected projection region.

FIG. 7A is a flowchart of an embodiment of a method for analyzing images of a physical environment to identify projection region(s) over which a virtual object can be displayed using an AR device

FIG. 7B is a flowchart of another embodiment of a method for analyzing images of a physical environment to identify projection region(s) over which a virtual object can be displayed using an AR device;

FIG. 8, is a flowchart of another embodiment of a method for analyzing images of a physical environment to identify projection region(s) over which a virtual object can be displayed using an AR device;

FIG. 9A through FIG. 9D are graphical representations portions of the methods of FIG. 7A, FIG. 7B and FIG. 8;

FIG. 10 is a functional block diagram of an embodiment of a system for displaying user interactions with virtual objects over physical objects, and for displaying user interactions with physical objects on or over virtual objects;

FIG. 11A is a flowchart of an embodiment of a method for displaying a user interaction with a virtual object over a physical object;

FIG. 11B is a flowchart of an embodiment of a method for displaying a user interaction with a physical object on or over a virtual object;

FIG. 12A through FIG. 12C are graphical representations of an embodiment of methods for generating an overlay that represents a user interaction with a virtual object, and displaying the overlay over a physical object that is represented by the virtual object.

FIG. 13A through FIG. 13C are graphical representations of an embodiment of methods for generating an overlay that represents a user interaction with a physical object, and displaying the overlay on or over a virtual object that represents the physical object;

FIG. 14A through FIG. 140 are graphical representations of an embodiment of methods for displaying different portions of an overlay over respective portions of a physical object depending on a view area of an AR device;

FIG. 15A and FIG. 15B are graphical representations of an embodiment of a method for determining where to display an overlay;

FIG. 16A is a functional block diagram of an embodiment of a system for determining where to display an avatar in a physical environment that is in view of an AR device;

FIG. 16B is a functional block diagram of another embodiment of a system for determining where to display an avatar in a physical environment that is in view of an AR device;

FIG. 17A is a flowchart of an embodiment of a method for determining where to display an avatar in a physical environment that is in view of an AR device;

FIG. 17B is a flowchart of another embodiment of a method for determining where to display an avatar in a physical environment that is in view of an AR device;

FIG. 18 is a flowchart of another embodiment of a method for determining where to display an avatar in a physical environment that is in view of an AR device;

FIG. 19 is a flowchart of another embodiment of a method for determining where to display an avatar in a physical environment that is in view of an AR device;

FIG. 20A is a functional block diagram of an embodiment of a system for determining where to position an avatar of a remote user in a physical environment for display in virtual environments in view of two or more AR devices;

FIG. 20B is a functional block diagram of another embodiment of a system for determining where to position an avatar of a remote user in a physical environment for display in virtual environments in view of two or more AR devices;

FIG. 21 is a flowchart of another embodiment of a process for determining where to display an avatar relative to positions of two or more AR users in a physical environment; and

FIG. 22 is a functional block diagram of an embodiment of a system for generating an avatar that represents an AR user.

### DETAILED DESCRIPTION

This disclosure includes various approaches for enabling display of virtual information during mixed reality experiences, which in include any or all of virtual reality (VR), augmented reality (AR), and hybrid reality experiences. Four different types of approaches or methods for enabling display of virtual information are discussed below. A first set of approaches determine how to display virtual information using an AR device. A second set of approaches determine where to display virtual information using an AR device. A third set of approaches display remote interactions with a virtual object over a physical object. A fourth set of approaches determine where to position an avatar in a physical environment in which one or more AR users are present. Different combinations of these approaches may be used in different embodiments (e.g., one embodiment may determine how and where to display a virtual object or an avatar using an AR device, or other embodiments comprising other combinations of the approaches).

Further details about each of the above approaches are provided after the following brief description of systems that are implicated by these approaches.

Similar systems and methods are disclosed in U.S. Provisional Patent Application Ser. No. 62/580,101, filed Nov. 1, 2017, entitled “SYSTEMS AND METHODS FOR DETERMINING WHEN TO PROVIDE EYE CONTACT FROM AN AVATAR TO A USER VIEWING A VIRTUAL ENVIRONMENT,” U.S. Provisional Patent Application Ser. No. 62/580,112, filed Nov. 1, 2017, entitled, “SYSTEMS AND METHODS FOR USING A CUTTING VOLUME TO DETERMINE HOW TO DISPLAY PORTIONS OF A VIRTUAL OBJECT TO A USER,” U.S. Provisional Patent Application Ser. No. 62/580,124, filed Nov. 1, 2017, entitled, “SYSTEMS AND METHODS FOR TRANSMITTING FILES ASSOCIATED WITH A VIRTUAL OBJECT TOA USER DEVICE BASED ON DIFFERENT CONDITIONS,” U.S. Provisional Patent Application Ser. No. 62/580,128, filed Nov. 1, 2017, entitled, “SYSTEMS AND METHODS FOR DETERMINING HOW TO RENDER A VIRTUAL OBJECT BASED ON ONE OR MORE CONDITIONS,” U.S. Provisional Patent Application Ser. No. 62/580,132, filed Nov. 1, 2017, entitled, “SYSTEMS AND METHODS FOR ENCODING FEATURES OF A THREE-DIMENSIONAL VIRTUAL OBJECT USING ONE FILE FORMAT,” and U.S. Provisional Patent Application Ser. No. 62/593,071, filed Nov. 30, 2017, entitled, “SYSTEMS AND METHODS FOR ENCODING FEATURES OF A THREE-DIMENSIONAL VIRTUAL OBJECT USING ONE FILE FORMAT,” the contents of which are hereby incorporated by reference in their entirety.

### Example Systems

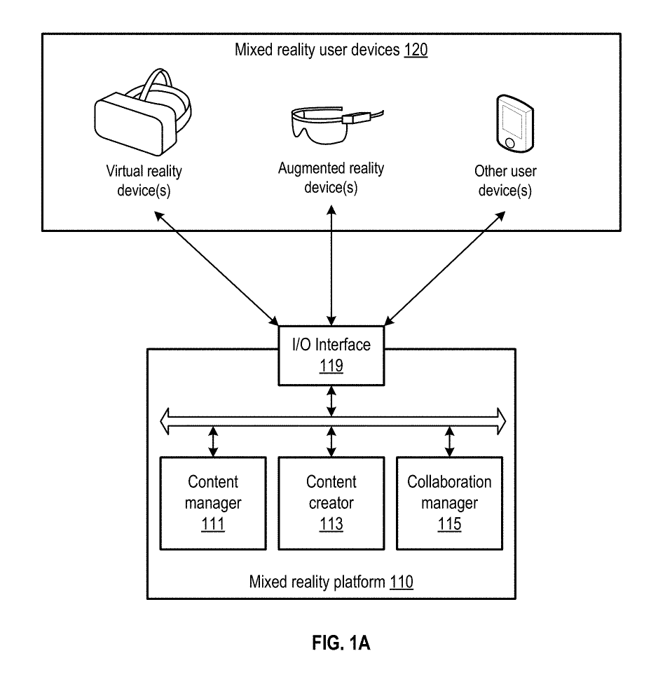

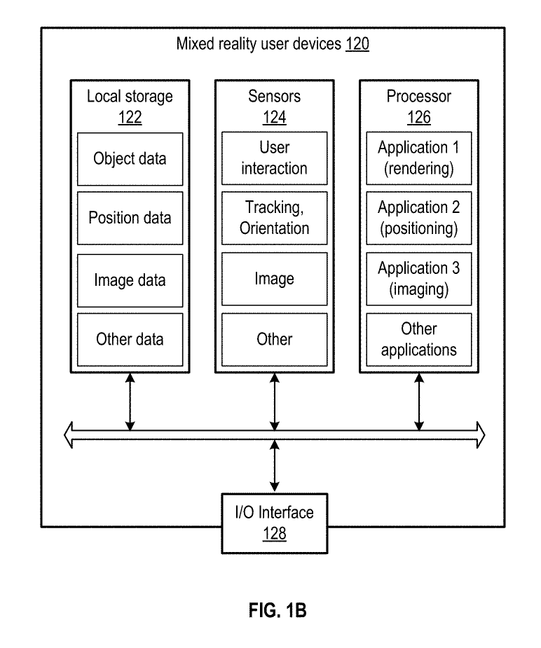

FIG. 1A and FIG. 1B are functional block diagrams of embodiments of a positioning system for enabling display of virtual information during mixed reality experiences. FIG. 1A and FIG. 1B depict aspects of a system on which different embodiments are implemented for enabling display of virtual information during mixed reality experiences. A system for creating computer-generated virtual environments and providing the virtual environments as an immersive experience for users is shown in FIG. 1A. The system includes a mixed reality platform (platform) 110 that is communicatively coupled to any number of mixed reality user devices 120 such that data can be transferred between them as required for implementing the functionality described below in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment. Raw data may be received from any source, and then converted to virtual representations of that data. Different versions of a virtual object may also be created. Modifications to a virtual object are also made possible by the content creator 111. The platform 110 and each of the content creator 113, the collaboration manager 115, and the I/O interface 119 can be implemented as one or more processors operable to perform the functions described herein. The content manager 113 can be a memory that can store content created by the content creator 111, rules associated with the content, and also user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120.

Each of the user devices 120 include different architectural features, and may include the features shown in FIG. 1B, including a local storage 122, sensors 124, processor(s) 126, and an input/output interface 128. The local storage 122 stores content receive from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each of user device 120 manages transmissions between that user device and the platform 110. The sensors 124 may include inertial sensors that sense movement and orientation (e.g., gyros, accelerometers and others), location sensors that determine position in a physical environment, cameras or other optical sensors that capture images of the physical environment or user gestures, audio sensors that capture sound, and/or other known sensor(s).

Some of the sensors 124 (e.g., inertial and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a command is provided to make the desired modification.

Some sensors 124 (e.g., cameras and other optical sensors of AR devices) are also used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using different known approaches. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used instead of a camera. Textures, colors and other features of physical objects or physical environments can be determined by analysis of individual images.

Example user devices include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

### Determining how to Display Virtual Information Using an AR Device

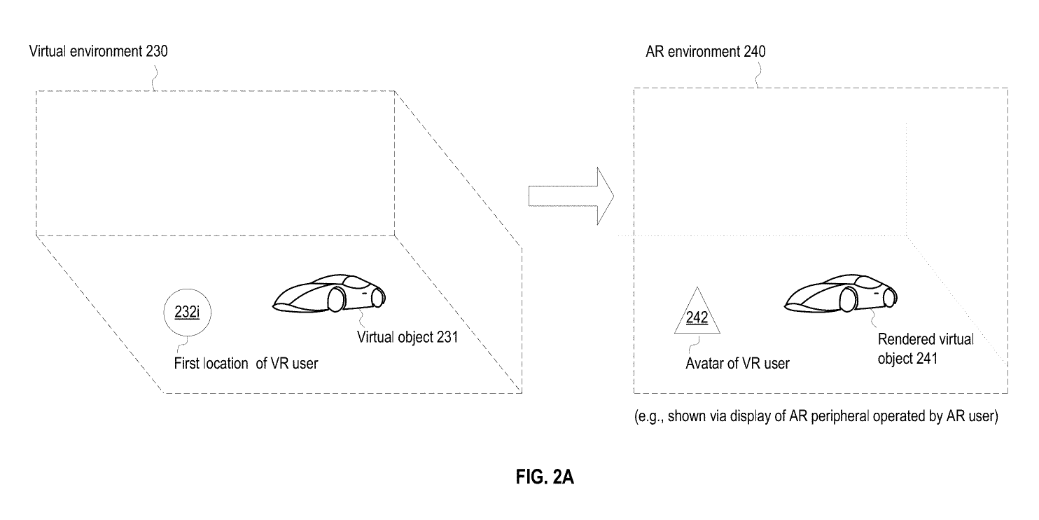

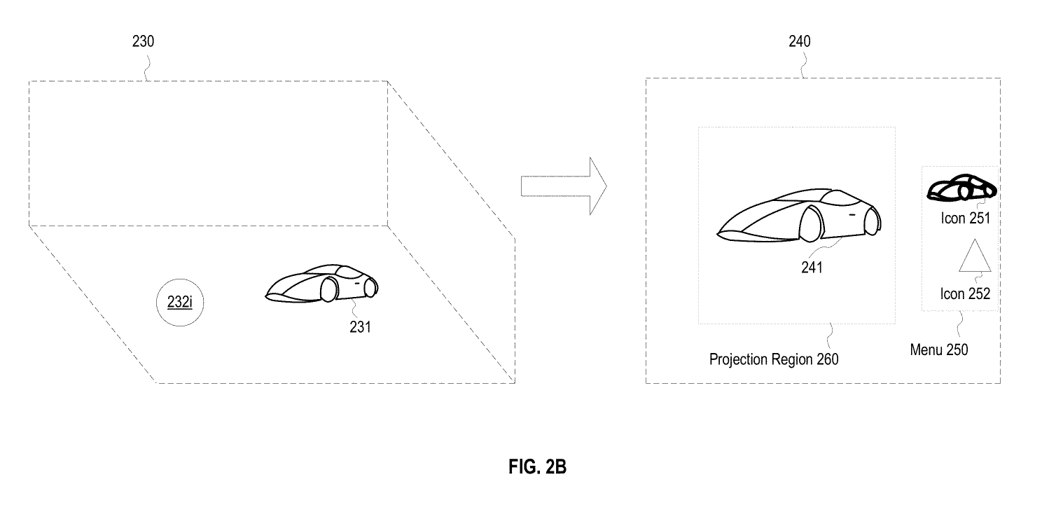

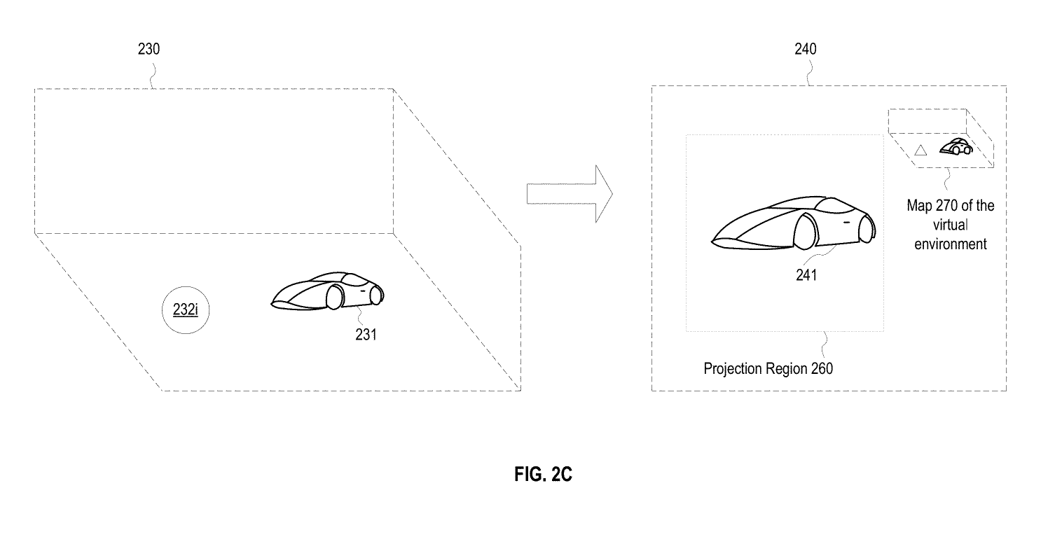

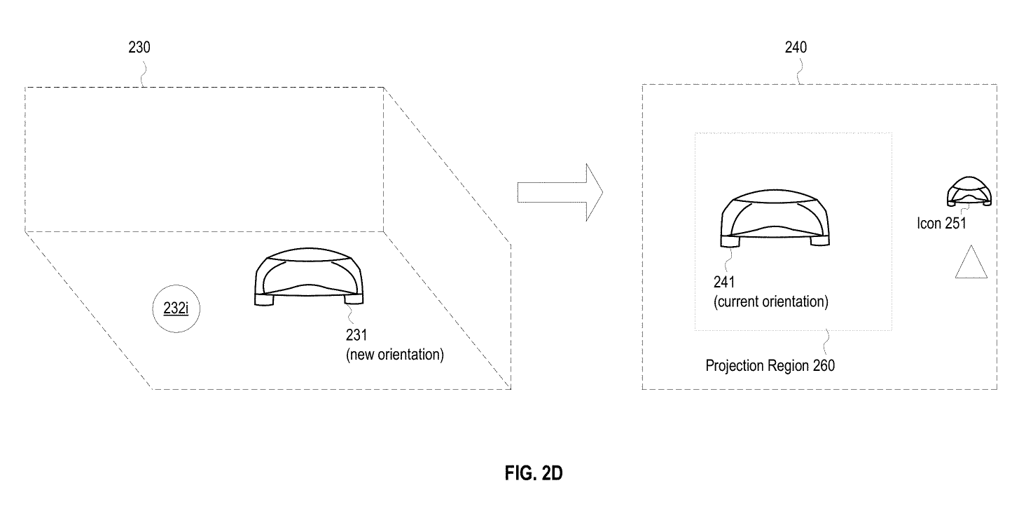

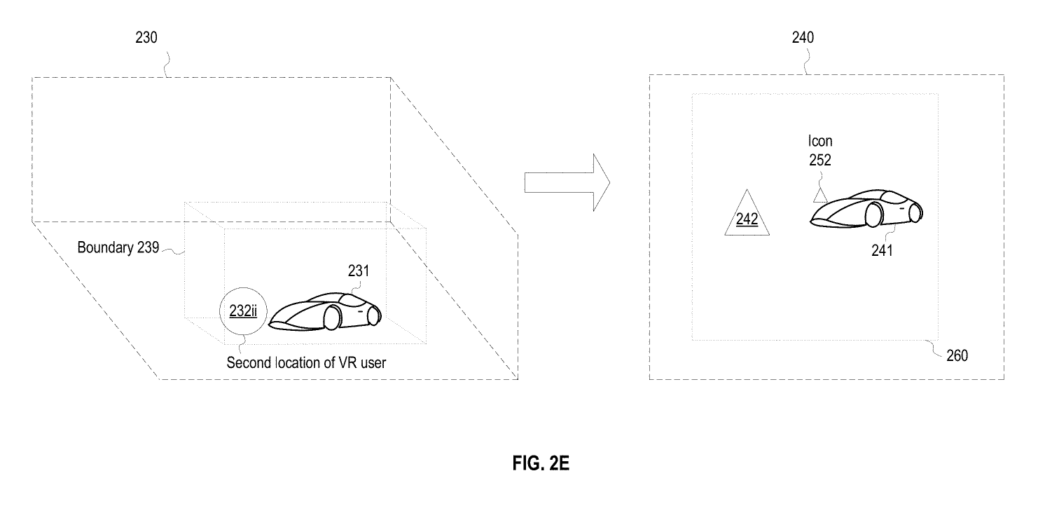

FIG. 2A through FIG. 2E are graphical representations of embodiments of processes for displaying virtual objects of a virtual environment using an AR device. FIG. 2A through FIG. 2E illustrate different approaches for displaying virtual objects of a virtual environment using an AR device operated by an AR user depending on different circumstances.

In FIG. 2A, positions of a virtual object 231 and a first location 232i of a VR user are tracked in a virtual environment using known techniques. A rendered virtual object 241 and an avatar 242 representing the VR user are displayed in an AR virtual environment 240 shown via a display of an AR device. The relative positions of the rendered virtual object 241 and the avatar 242 are the same as the relative positions of the virtual object 231 and the first location 232i. Different techniques may be used to render the same relative positions. One technique includes determining a virtual pose (e.g., position and orientation) of the AR user in the virtual environment 230, determining positions and orientations of the virtual object 231 and the first location 232i relative to the virtual pose, determining a physical pose (e.g., position and orientation) of the AR user in the physical environment, and then using the AR device to display the rendered virtual object 241 and the avatar 242 in the AR virtual environment 240 so they appear at positions and orientations relative to the physical pose of the AR user that match the positions and orientations of the virtual object 231 and the first location 232i relative to the virtual pose. For purposes of illustration the virtual environment 230 in FIG. 2A is depicted as would be seen from an illustrative virtual pose of an AR user.

In cases where the size of the AR virtual environment 240 is smaller than the virtual environment 230, virtual things and their relative positions can be scaled to fit the AR virtual environment 240. In other circumstances discussed below, such scaling may not be desired where larger images of virtual things need to be displayed.

Another approach for displaying virtual information is illustrated in FIG. 2B. As shown, only a subset of virtual things from the virtual environment 230 may be displayed at a time in the AR virtual environment 240. By way of example, the rendered virtual object 241 is displayed, but the avatar 242 is not displayed. There are several reasons for doing so, including (i) AR user preference, (ii) a smaller view area of the AR virtual environment 240 that is capable of displaying less virtual things compared to a larger view area of the virtual environment 230 that is capable of displaying more virtual things, (iii) required or desired size of a displayed thing (e.g., where the rendered virtual object 241 is to be displayed at a particular minimum size), (iv) rules that dictate display of particular virtual things (e.g., the rendered virtual object 241 is selected by another user for display to the AR user), or (v) another reason.

In other embodiments, the AR user may select particular things to display using a menu 250 that includes selectable icons 251 and 252, which can each be respectively selected to cause the rendered virtual object 241 and the avatar 252 to be respectively displayed in the AR virtual environment 240. The icons 251 and 252 may be smaller images of their respective virtual thing (e.g., the rendered virtual object 241 and the avatar 242). The icon representing the virtual thing being displayed may also be highlighted, bolded, or look differently than other icons to indicate it is being displayed. Display of virtual things may occur in a projection region 260 that covers only part the view area of the AR virtual environment. Determining and defining projection regions are discussed later in a different section. Such projection regions may be required or desired when particular features of a physical environment into which the AR virtual environment 240 is projected provide a poor background in front of which virtual things can be projected in the AR virtual environment 240—e.g., when characteristics (e.g., color contrast, other) of the virtual thing and of the physical feature do not meet a minimum threshold condition (e.g., color contrast condition, other condition).

Another approach for displaying virtual information is illustrated in FIG. 2C, which depicts a small map 270 of the virtual environment 230. The map 270 may be used to (i) provide information to the AR user on positions or actions related to virtual things, (ii) select icons displayed therein like the icons from the menu 250 of FIG. 2B, or (iii) other uses.

As shown in FIG. 2D, changes to virtual things (e.g., the new orientation of the virtual object 231) in the virtual environment 230 are replicated for virtual things (e.g., the new orientation of the rendered virtual objects 241) shown in the AR virtual environment 240. Icons representing the virtual things (e.g., the icon 251) may also show the changes.

As illustrated by FIG. 2E, when only some virtual things are displayed in the AR virtual environment (e.g., the rendered virtual object 241), other virtual things (e.g., the avatar 242) may come into view in the AR virtual environment 240 when positions of those other virtual things (e.g., the section location 232ii of the VR user) pass through a boundary 239 in the virtual environment 230. Alternatively, an icon (e.g., the icon 252) representing the other virtual thing may be shown to indicate the other virtual thing is near or interacting with the virtual thing. Examples of boundaries include (i) a three-dimensional volume that encloses the virtual thing, (ii) a two-dimensional area, or (iii) other type of boundary. The boundaries can be treated as a virtual thing in the virtual environment 230 that may or may not be shown to a user.

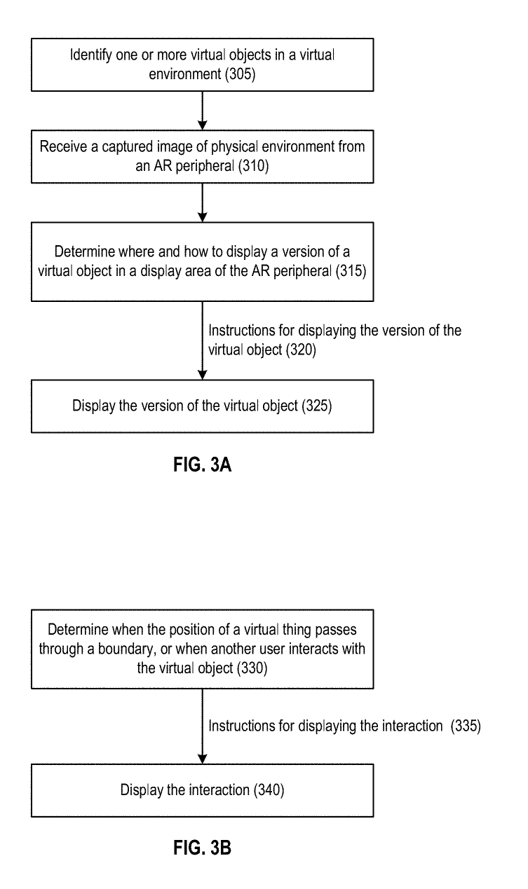

FIG. 3A and FIG. 3B are flowcharts of embodiments of processes for determining how to display virtual objects of a virtual environment using an AR device. The processes for determining how to display virtual objects of a virtual environment using an AR device of FIG. 2A and FIG. 3B can depend on various circumstances.

As shown in FIG. 3A, one or more virtual things in a virtual environment can be identified at block 305 (305). By way of illustration, and with reference to FIG. 2A, virtual things may include the virtual object 231 and the first position 232i of the VR user. A captured image of a physical environment from an AR device is received (310), and a determination is made as to where and how to display a versions of the virtual things in a display area of the AR device (315). By way of example, FIG. 2A through FIG. 2E depict different approaches for displaying a rendered version of a virtual thing. Instructions for displaying the version of the virtual thing are provided to a renderer of the AR device (320), and the AR device displays the version of the virtual object (325). In some embodiments, these functions can be performed by the platform 110. In some other embodiments, these functions can be performed collaboratively between the platform 110 and the devices 120.

As shown in FIG. 3B, a determination is made as to when the position of a virtual thing passes through a boundary, or when another user interacts with the virtual object (330). Instructions for displaying the virtual thing or the interaction are provided to the AR device (335), and the AR device displays a version of the virtual thing or the interaction (340).

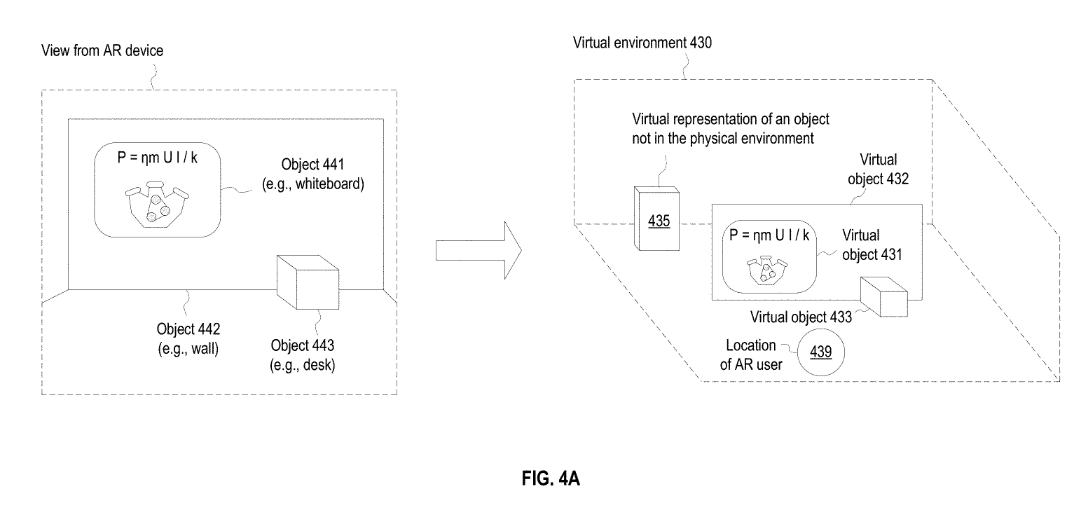

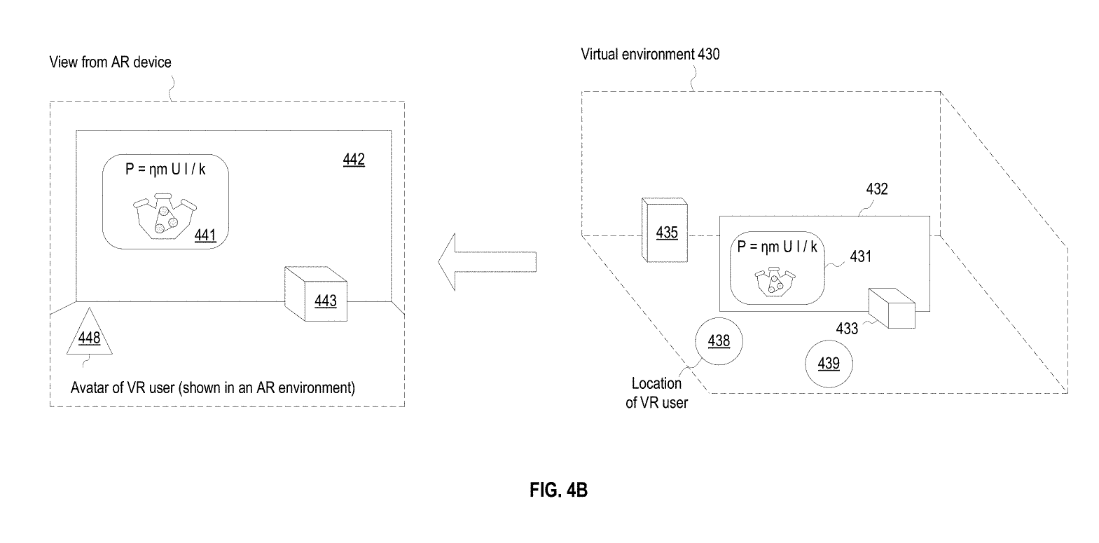

FIG. 4A and FIG. 4B are graphical representations of embodiments of processes for (i) generating virtual objects that represent physical objects of a physical environment in view of an AR device, (ii) positioning the generated virtual objects in a virtual environment so the virtual objects can be viewed by a remote user of another device, and (iii) using the AR device to display an interaction between the remote user and the generated virtual objects.

An approach or method for generating virtual objects that represent physical objects of a physical environment in view of an AR user operating an AR device, and for positioning the generated virtual objects in a virtual environment so the virtual objects can be viewed by a remote user of another device, is demonstrated in FIG. 4A. Different approaches can be used to generate a virtual object that represents a physical object. In one approach, three-dimensional points are captured based on two-dimensional images of a physical object. The three-dimensional points are analyzed to extract surfaces, depths, and other structural properties of the physical object. Color and texture can be determined analyzing the two-dimensional images. Techniques for such analysis include segmentation and other image analysis techniques. Once virtual objects (e.g., virtual objects 431, 432, and 433) that represent physical objects (e.g., whiteboard object 441, a wall object 442, and a desk object 443) have been generated, those virtual objects are displayed in the virtual environment 430. Display of the virtual objects may match how the physical objects are displayed in the physical environment, or may be otherwise displayed. Relative positioning of the virtual objects in the virtual environment 430 based on relative position of the physical objects they respectively represent may be determined using the geospatial mapping of the physical environment. The pose of the AR user may be used to map a position of the user in the virtual environment (see, e.g., location of AR user 439) relative to positions of the virtual objects. The virtual environment 230 need not be exclusive to the virtual objects that represent physical objects, such that another virtual object 435 may also be displayed in the virtual environment 430, as show in FIG. 4A.

As illustrated by FIG. 4B, interactions by other users (e.g., a VR user) with the virtual objects that represent physical objects can be tracked in the virtual environment 430, and used to display avatars of the other users (e.g., avatar 448) in an AR virtual environment projected into the physical environment by the AR device. The location and orientation of a displayed avatar for a user relative to positions of physical objects in a geospatial map of the physical environment may match the location and orientation of the user relative to virtual objects that represent those physical objects in a geospatial map of the virtual environment 430. When the position of the avatar 448 in the geospatial map of the physical environment is in the view area of the AR user, then the avatar 448 is displayed to the AR user relative to the positions of the physical objects.

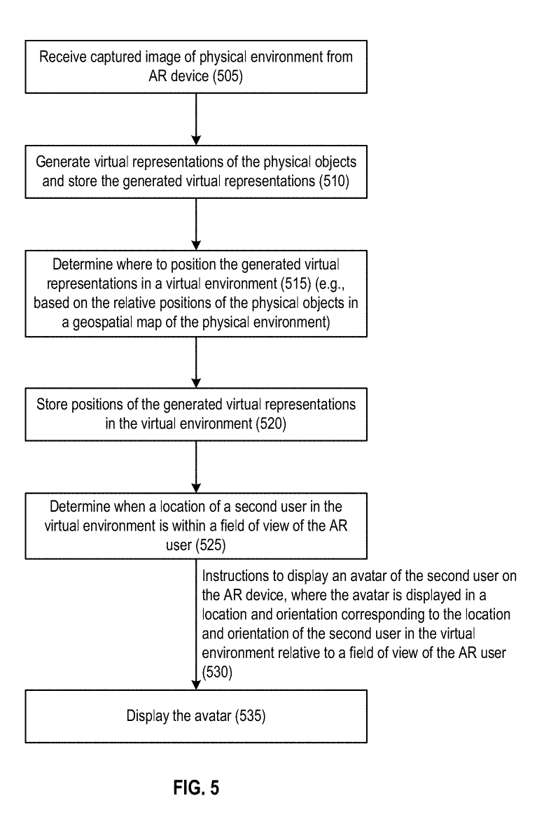

FIG. 5 is a flowchart of a method for (i) generating virtual objects that represent physical objects of a physical environment in view of an AR device, (ii) positioning the generated virtual objects in a virtual environment so the virtual objects can be viewed by a remote user of another device (e.g., the VR user), and (ii) using the AR device to display an interaction (e.g., proximity) between the remote user and the generated virtual objects. Images of a physical environment are captured using an AR device (505), and used to generate virtual representations of the physical objects in the physical environment, which are stored (510), to a memory, for example. A determination is made as to where to position the generated virtual representations (e.g., candidate positions) in a virtual environment (515)—e.g., position them in a section of the virtual environment 430 free of other objects, position them at locations selected by a user, or another approach. Positions of the generated virtual representations in the virtual environment are stored (520)—e.g., for later use in generating instructions to display virtual representations to another user. A determination is made as to when a location of a second user in the virtual environment is within a virtual view area of the AR user in the virtual environment (525), instructions to display an avatar of the second user on the AR device are provided to the AR device (530), and the avatar is displayed at a location relative to the pose of the AR user in the physical environment that corresponds to the position of the second user relative to a position of the AR user in the virtual environment (535).

Determining where to Display Virtual Information Using an AR Device

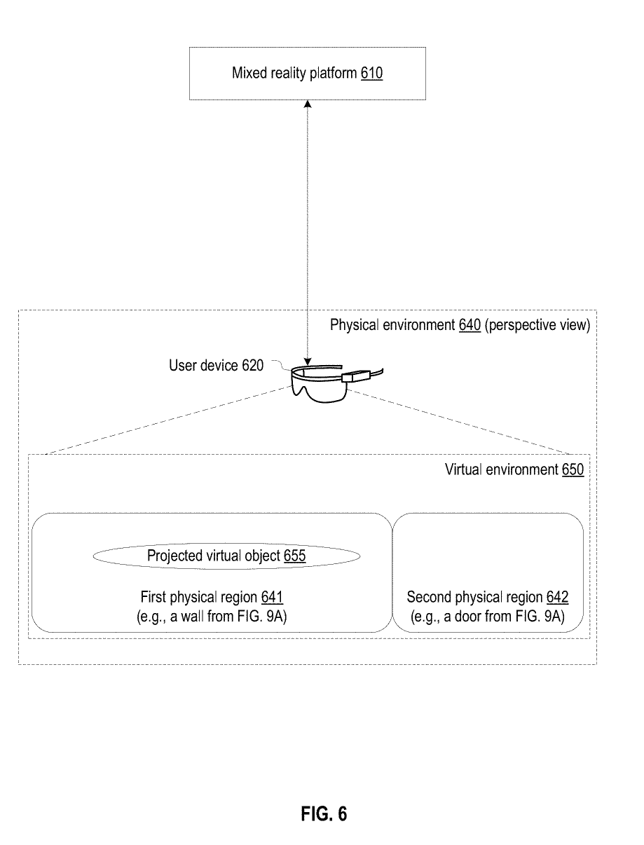

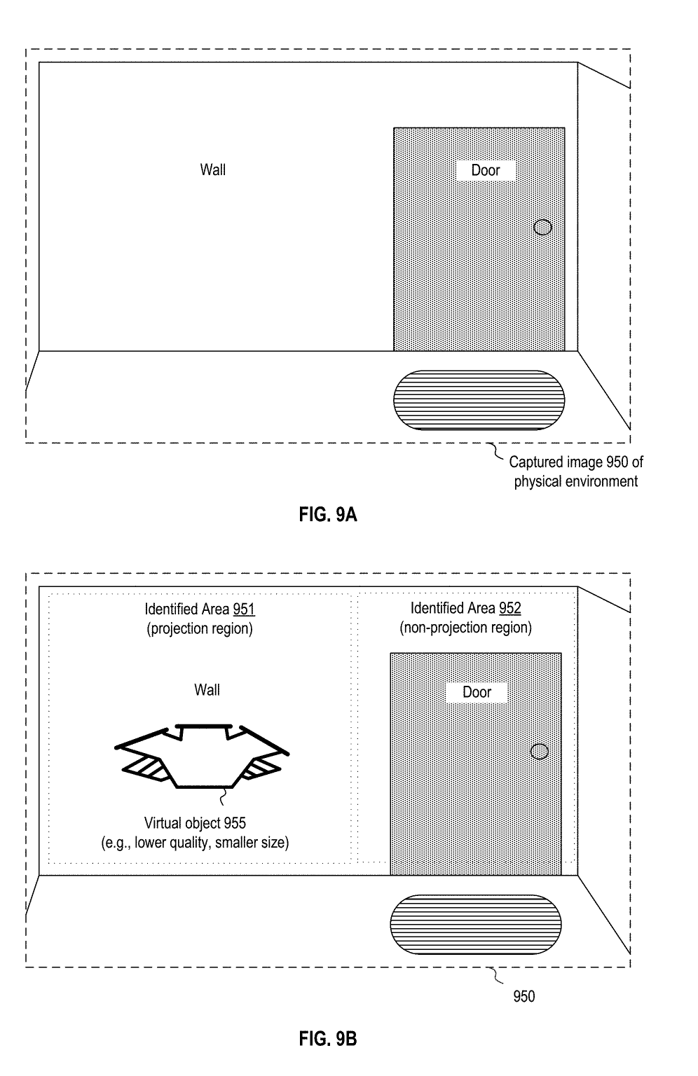

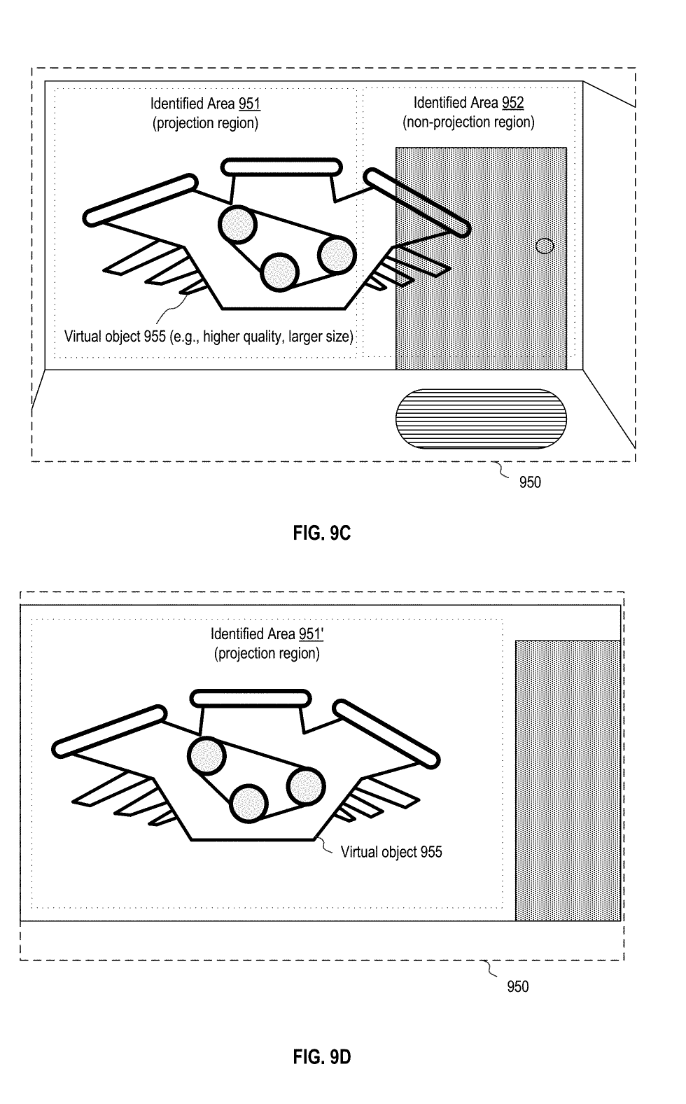

FIG. 6 is a functional block diagram of an embodiment of a system for (i) analyzing images of a physical environment to identify projection region(s) over which a virtual object can be displayed using an AR device, (ii) optionally requesting user action to enable a different projection region, and (iii) displaying the virtual object in a selected projection region. As shown, the system in FIG. 6 includes a mixed reality platform 610 (similar to the mixed reality platform 110), a user device 620 (e.g., an AR device), a physical environment 640 in which the user device 620 resides, a first physical region 641 (e.g., a wall from FIG. 9A) and a second physical region 642 (e.g., a door from FIG. 9A) of the physical environment 640 that are in view of a user operating the user device 620, a virtual environment 650 projected by the user device 620, and a virtual object 655 displayed in the virtual environment 650 and projected over or into the first physical region 641.

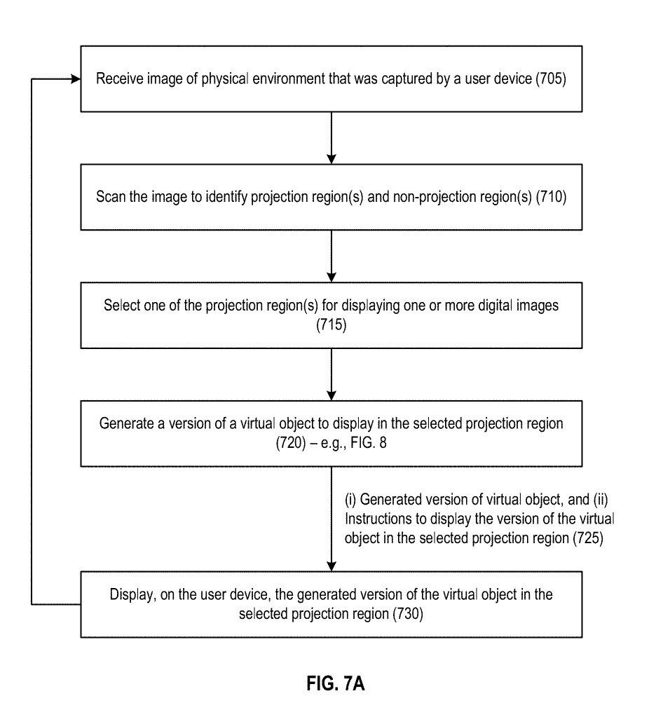

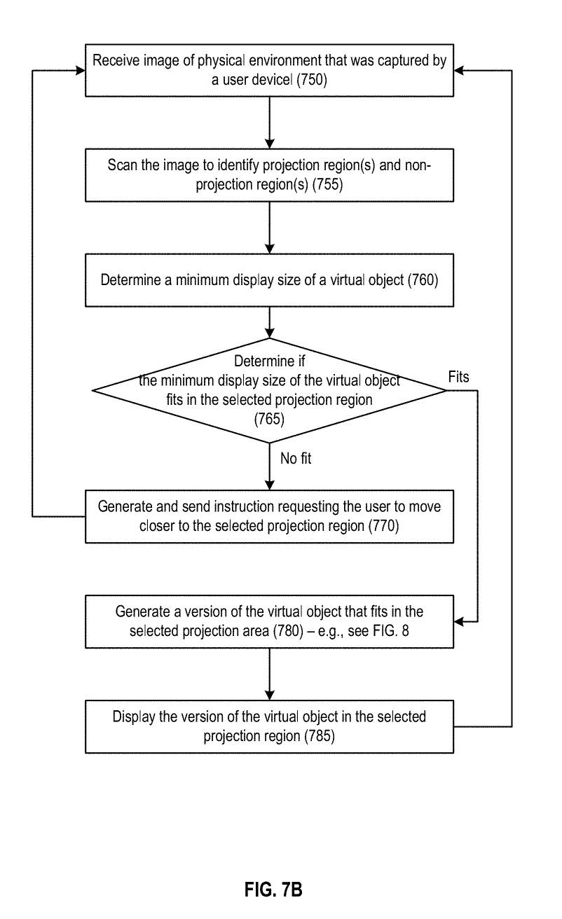

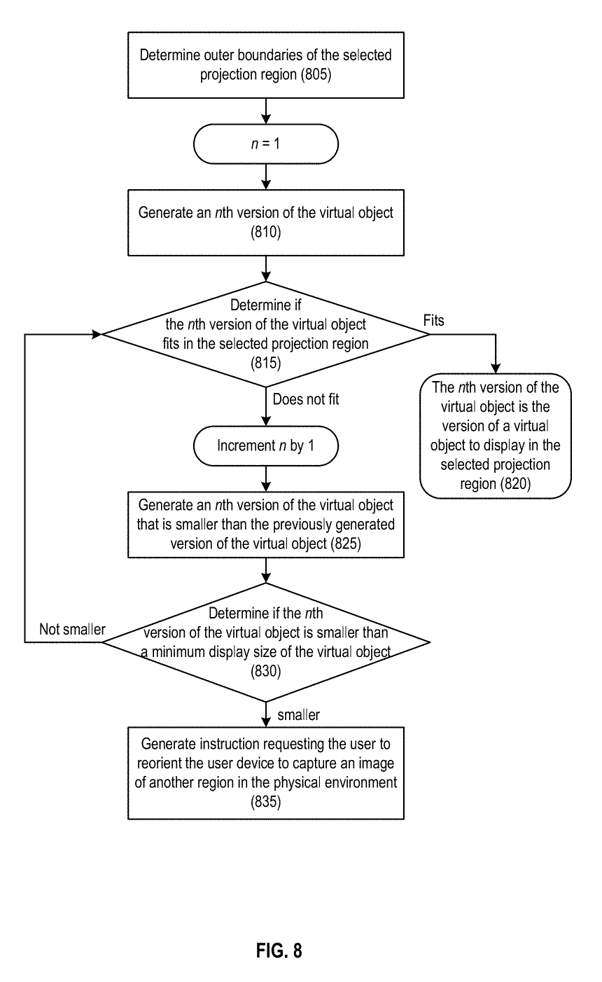

FIG. 7A, FIG. 7B and FIG. 8 are flowcharts of embodiments of methods for (i) analyzing images of a physical environment to identify projection region(s) over or into which a virtual object can be displayed using an AR device, (ii) optionally requesting user action to enable a different projection region, and (iii) displaying the virtual object in a selected projection region.

As shown in FIG. 7A, one or more images of a physical environment that were captured by a user device (e.g., the mixed reality device 110, 610) are received (705). The image is scanned to identify projection region(s) and non-projection region(s) (710). One of the projection region(s) is selected for displaying one or more digital images (715). A version of a virtual object to display in the selected projection region is generated (720). The generated version of the virtual object, and instructions to display the version of the virtual object over or into the selected projection region are provided to the AR device (725). The generated version of the virtual object is then displayed over or into the selected projection region using the AR device (730).

Different approaches may be used to identify projection and non-projection region(s) during step 710. In one embodiment, a projection region includes a recognized object (e.g., wall, desk, floor, whiteboard, other), and non-projection regions do not include any recognized object (e.g., no wall, desk, floor, whiteboard, other). In another embodiment, each projection region includes a group of pixels where the color of each pixel in the group is within a predefined range of colors, and each pixel in the group is next to at least one other pixel in the group, where non-projections do not meet this condition. In yet another embodiment, each projection region is a 2D or 3D geometric shape (rectangle, rectangular prism) with respective minimum numbers of pixels along the each axis (x,y,z) where the color of each pixel in the shape is within a predefined range of colors, and each pixel in the shape is next to at least one other pixel in the group. Non-projections do not meet this condition. In yet another embodiment, a projection region includes a recognized object without any other objects (e.g., a portion of a wall clear of wall hangings and in front of which no other objects are positioned).

In different embodiments, the selection of one projection region over another projection region will vary. In one embodiment, the selection is based on relative sizes of the projection regions where the larger region is selected. In another embodiment, the selection is based on the colors of each projection region, where the region with a particular color characteristic (e.g., the lightest color) is selected. In yet another embodiment, the selection is based on the color contrast between each projection region and the colors in the virtual object, where the region with the greatest color contrast is selected. Other approaches may be used. In some embodiments, a selected projection region corresponding to a physical space may change depending on characteristics of the virtual object that is to be displayed. For example, the size, color(s), or other characteristic(s) of the virtual object may dictate which of a plurality of projection regions is selected. In some embodiments, selection of the projection region may be determined based on user preference, where different preferences of different users in the same or similar physical space may result in selection of different projection regions for displaying the same virtual object. Examples of user preferences include color preferences, visual disabilities (e.g., color blindness, limited depth perception, or others), or other preferences.

Different versions of the virtual object may be determined for use with projection regions that have particular characteristics. In one embodiment, a less-detailed version of a virtual object is displayed in a projection region that is smaller than a required minimum size for projecting a more-detailed version of the virtual object. In another embodiment, a version of a displayed virtual object has a particular set of colors that match or contrast a projection region better than another set of colors available for displaying the virtual object. In yet another embodiment, a displayed version of the virtual object has thicker edges or lines that are easier to see in a selected projected region compared to thinner edges or lines. In yet another embodiment, a displayed version of a virtual object has less colors (e.g., black and white) compared to another version of the virtual object (e.g., colorized). The different versions of the virtual object discussed above may also be determined and displayed based on user preferences.

In some embodiments, an administrator or other individual controls the selection of projection region, the generation of a visual object's version, and the display of the generated version relative to each user. In other embodiments, each user controls the selection, generation and display.

In some circumstances, dimensions of a version of a virtual object may exceed corresponding dimensions of a candidate projection region. Therefore, in some embodiments, a determination is made as to whether a candidate projection region is large enough to display a version of a virtual object—e.g., such that the virtual object is viewable to the AR user with enough resolution, detail, or other characteristics. A process for determining whether a potential projection region is large enough to display a version of a virtual object is shown in FIG. 7B. As shown in FIG. 7B, an image of a physical environment that was captured by a user device is received (750), and the image is scanned to identify projection region(s) and non-projection region(s) (755). A minimum display size of a virtual object is determined (760). A determination is made as to whether the minimum display size of the virtual object fits in a selected projection region (765). If the minimum display size of the virtual object does not fit, an instruction requesting the user of the AR device to move closer to the selected projection region is generated (770), and the process returns to step 750. If the minimum display size of the virtual object fits, a version of the virtual object that fits in the selected projection area is generated (780), the version is displayed in the selected projection region (785), and the process returns to step 750. The size of the generated version need not be the minimum display size.

By way of example, the process of FIG. 8 may be used to generate the largest version of a virtual object that fits in the selected projection region. As shown in FIG. 8, outer boundaries of the selected projection region are determined (805). An nth version of the virtual object is generated (810). A determination is made as to whether the nth version of the virtual object fits in the outer boundaries (815). If the nth version of the virtual object fits in the selected projection region, the nth version of the virtual object is the version of a virtual object to display in the selected projection region (820). If the nth version of the virtual object does not fit in the selected projection region, n is incremented by 1, and a new nth version of the virtual object that is smaller than the previously generated version of the virtual object is generated (825). After step 825, a determination is made as to whether the nth version of the virtual object is smaller than a minimum display size of the virtual object (830). If the nth version of the virtual object is not smaller than a minimum display size of the virtual object, the process returns to step 815. If the nth version of the virtual object is smaller than a minimum display size of the virtual object, an instruction requesting the user to reorient the user device to capture an image of another region in the physical environment is generated (835). Instead of outer boundaries, dimensions or other size characteristics of the selected projection region can be determined during step 805, and a determination is made as to whether dimensions or other size characteristics of the nth version are smaller than the determined dimensions or size characteristics of the selected projection region during step 815. A fit may occur when the version's dimensions or other size characteristics are smaller than the region's dimensions or other size characteristics.

FIG. 9A through FIG. 9D illustrate aspects of the processes shown in FIG. 7A, FIG. 7B and FIG. 8. By way of example, FIG. 9A shows a captured image 950 of a physical environment that includes a wall and a door. As illustrated in FIG. 9B, a virtual object 955 is projected into a projection region, which is an identified area 951 (e.g., the wall) of the physical environment. A non-projection region, which is an identified area 952 (e.g., the door) of the physical environment is also shown. The identified area 951 may be suitable as a projection region because of its size, color, or other characteristic. The identified area 952 may not be suitable as a projection region because of its size, color, or other characteristic. In some circumstances, as illustrated by FIG. 9B, the virtual object 955 can be scaled in size or reduced in quality (e.g., details removed, or resolution lowered) to fit the projection region. In other circumstances, as illustrated by FIG. 9C, the required or desired size of the virtual object 955 may be larger than the size of the projection region. Under such circumstances, the user may be asked to reposition the AR device (e.g., approach the projection region to increase the size of the projection region to the identified area 951′ of FIG. 9D) so the required or desired size of the virtual object 955 fits in the projection region.

Displaying Remote Interactions with a Virtual Object Over a Physical Object

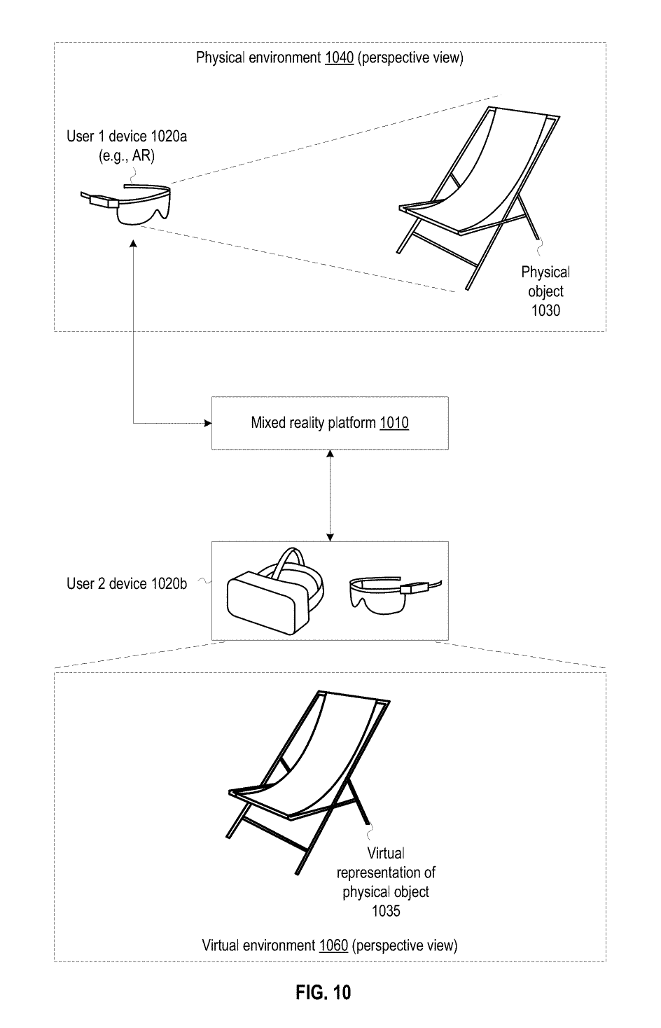

FIG. 10 is a functional block diagram of an embodiment of a system for displaying user interactions with virtual objects over physical objects, and for displaying user interactions with physical objects on or over virtual objects. As shown, the system includes a mixed reality platform 1010 (e.g., similar to the mixed reality platform 110, 610), a first user device 1020a (e.g., AR device) in a physical environment 1040, and a physical object 1030 in view of a first user operating the first user device 1020a. The system also includes a second user device 1020b that renders a virtual environment 1060 with a virtual representation (“virtual object”) 1035 of the physical object 1030 to a second user and that records interactions between the second user and the virtual object 1035.

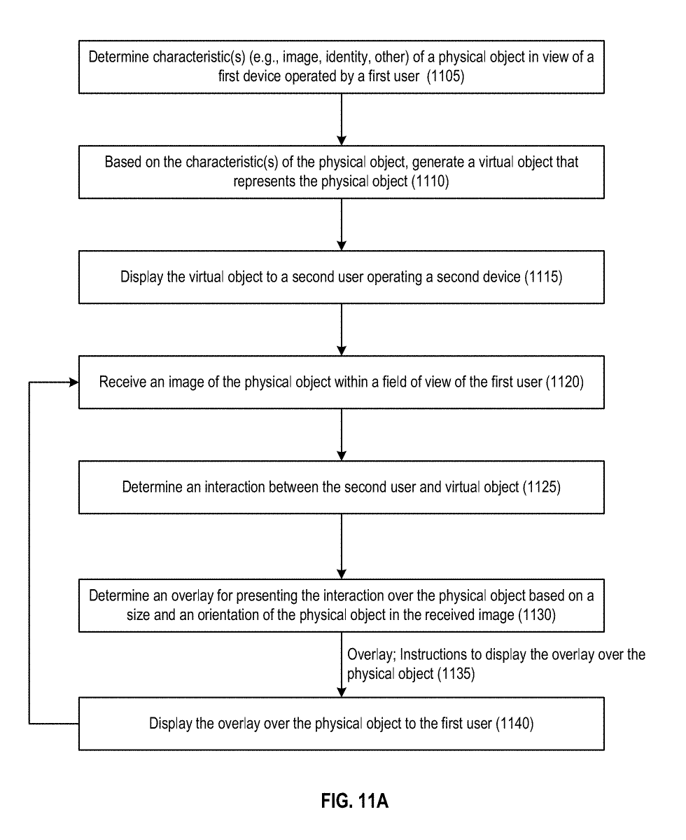

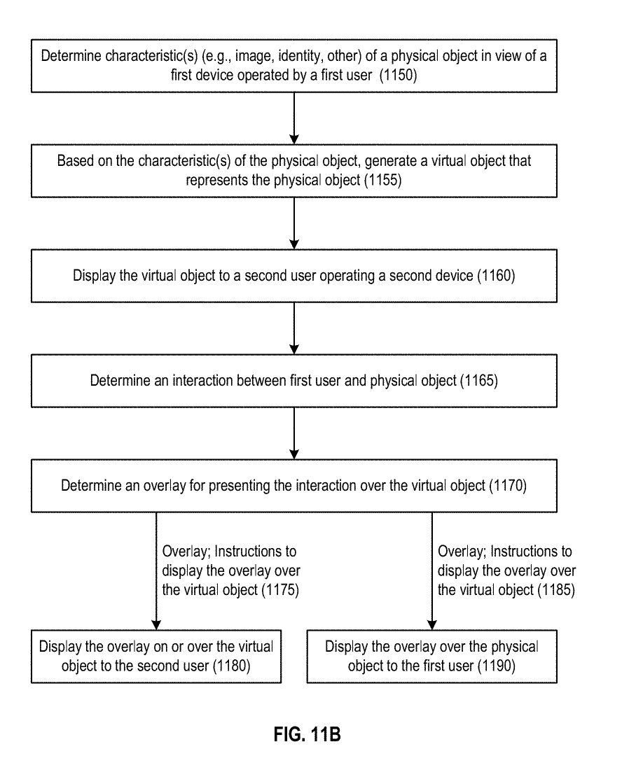

FIG. 11A is a flowchart of an embodiment of a method for displaying a user interaction with a virtual object over a physical object. Characteristic(s) of a physical object (e.g., the physical object 1030) in view of a first user operating a first AR device (e.g., the device 1020a) are determined (1105). Such characteristics may include image(s), an identifier, or another characteristic of the physical object. Based on the characteristic(s) of the physical object, a virtual object (e.g., the virtual object 1035) that represents the physical object is generated (1110). In an embodiment, three-dimensional points are captured based on two-dimensional images of the physical object. The three-dimensional points are analyzed to extract surfaces, depths, and other structural properties of the physical object. Color and texture can be determined analyzing the two-dimensional images. Any known approach may be used to generate the virtual object. The virtual object is displayed to a second user using a second device (e.g., device 1020b) (1115). An image of the physical object within a view area of the first user is received (1120), and an interaction between the second user and the virtual object is determined (1125). By way of example, an interaction may include the second user modifying a portion of the virtual object (e.g., adding color or a design), creating information to associate with a portion of the virtual object (e.g., labeling features), or another interaction. An overlay for presenting the interaction over the physical object based on a size and an orientation of the physical object in the received image is determined (1130). The overlay and instructions to display the overlay over the physical object of the received image are provided to the first device (1135), and the overlay is displayed over the physical object of the received image (1140).

Step 1130 may be carried out using different approaches. Using one approach, portions of the virtual object that were interacted with by the second user during step 1125 are identified using known techniques, a virtual representation of the physical object in the received image from step 1120 is determined, and portions of the virtual representation of the physical object in the received image from step 1120 that match the portions of the virtual object that were interacted with by the second user during step 1125 are identified. Identification of matching portions may be carried out using known techniques for matching the same objects of same or different sizes in different images. Locations of the interactions relative to the portions of the virtual object that were interacted with by the second user during step 1125 are identified (e.g., in terms of distance from the portions, points of intersection between the interactions and the portions, or other relative condition). Locations relative to the virtual representation of the physical object in the received image from step 1120 that match the locations of the interactions relative to the portions of the virtual object that were interacted with by the second user during step 1125 are identified. If the locations relative to the virtual representation of the physical object are in view of the first user, then the overlay depicts corresponding interactions at those locations. If the locations relative to the virtual representation of the physical object are not in view of the first user, then the overlay does not depict the corresponding interactions in the first user's view area, or the overlay depicts the corresponding interactions at different locations that are in view.

FIG. 11B is a flowchart of an embodiment of a method for displaying a user interaction with a physical object on or over a virtual object. Characteristic(s) of a physical object (e.g., the physical object 1030) in view of a first user operating a first AR device (e.g., the device 1020a) are determined (1150). Such characteristics may include image(s), an identity, or another characteristic of the physical object. Based on the characteristic(s) of the physical object, a virtual object (e.g., the virtual object 1035) that represents the physical object is generated (1155). The virtual object is displayed to a second user using a second device (e.g., device 1020b) (1160). An interaction between the first user and the physical object is determined (1165). By way of example, an interaction may include the first user making a gesture between a camera of the AR device and the physical object, physically modifying a portion of the physical object (e.g., coloring, shaping, printing, other), or another interaction. An overlay for presenting the interaction over the virtual object based on a size and an orientation of the virtual object as viewed by a second user is determined (1170). The overlay and instructions to display the overlay on or over the physical object of the received image are provided to the second device (1175), and the overlay is displayed on or over the virtual object to the second user (1180). Optionally, the overlay and instructions to display the overlay over the physical object are provided to the first device (1185), and the overlay is displayed over the virtual object to the first user (1190).

Step 1170 may be carried out using different approaches. Using one approach, portions of the physical object that were interacted with by the first user are identified using known techniques, and portions of the virtual object that match the portions of the physical object that were interacted with by the first user are identified. Identification of matching portions may be carried out using known techniques for matching the same objects of same or different sizes in different images. Locations of the interactions relative to the portions of the physical object that were interacted with by the first user are identified (e.g., in terms of distance from the portions, points of intersection between the interactions and the portions, or other relative condition). Locations relative to the virtual object that match the locations of the interactions relative to the portions of the physical object are identified. If the locations relative to the virtual object are in view of the second user, then the overlay depicts corresponding interactions at those locations. If the locations relative to the virtual object are not in view of the first user, then the overlay does not depict the corresponding interactions in the second user's view area, or the overlay depicts the corresponding interactions at different locations that are in view.

During embodiments where steps 1130 and 1170 occur at or near the same time (e.g., an overlay is created during step 1130 and another overlay is created during step 1170), or where two instances of step 1130 or of step 1170 occur at or near the same time, each overlay may be shown as described in FIG. 11A and FIG. 11B. Alternatively, in some embodiments, only one of the overlays is shown at a time. In other embodiments, only one of steps 1130 and 1170, or only one instance of step 1130 or step 1170 is permitted during a time period.

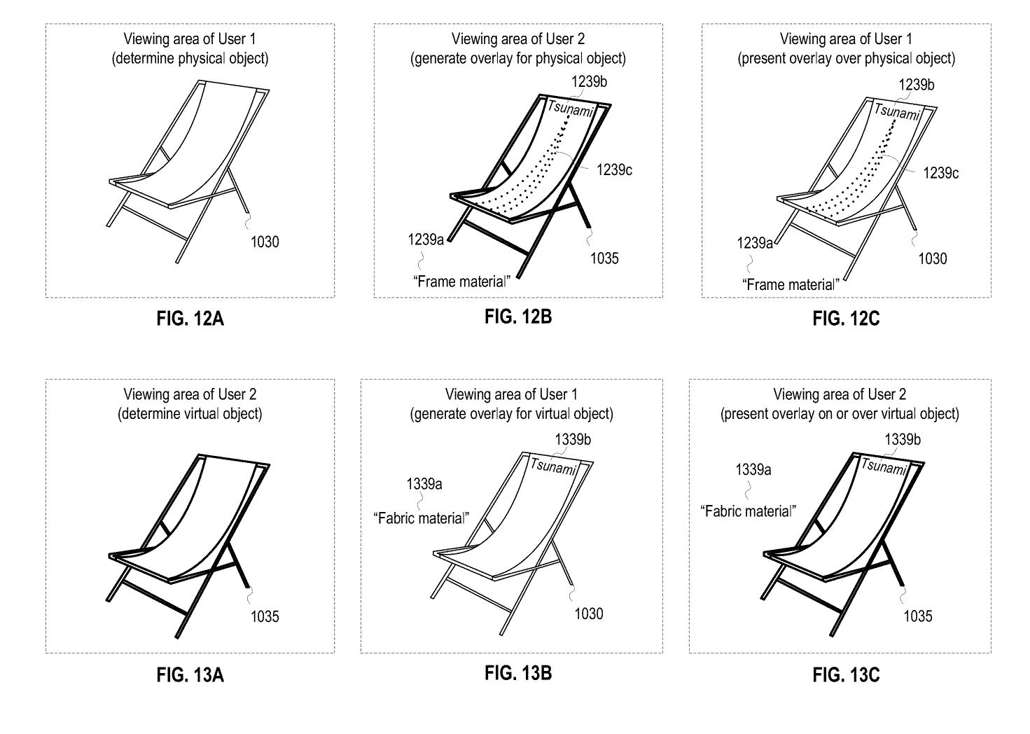

FIG. 12A through FIG. 120 are graphical representations of an embodiment of methods for generating an overlay that represents a user interaction with a virtual object, and displaying the overlay over a physical object that is represented by the virtual object. As shown in FIG. 12A, a viewing area of a first user is used to determine characteristics of the physical object 1030. In FIG. 12B, an overlay is generated by identifying interactions between a second user and the virtual object 1035. Such interactions include specifying a material 1239a (“Frame material”) like wood or metal, adding a logo 1239b (“Tsunami”), and adding a design 1239c. In FIG. 120, the viewing area of the first user presents the interactions over the physical object 1030.

FIG. 13A through FIG. 13C are graphical representations of an embodiment of methods for generating an overlay that represents a user interaction with a physical object, and displaying the overlay on or over a virtual object that represents the physical object. As shown in FIG. 13A, a viewing area of the second user presents the virtual object 1035. In FIG. 13B, an overlay is generated by identifying interactions between the first user and the physical object 1030. Such interactions include specifying a material 1339a (“Fabric material”) like natural or synthetic, and adding a logo 1339b (“Tsunami”). In FIG. 120, the viewing area of the second user presents the interactions over or on the virtual object 1035.

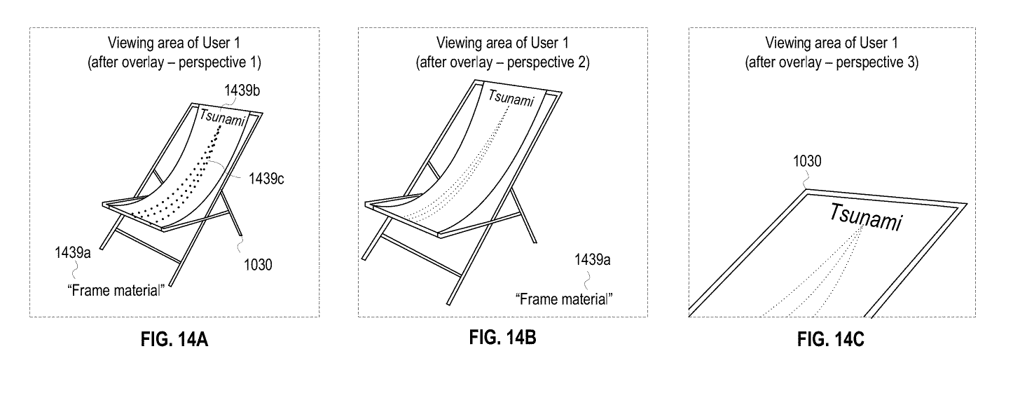

FIG. 14A through FIG. 140 are graphical representations of an embodiment of methods for displaying different portions of an overlay over respective portions of a physical object depending on a view area of an AR device. As shown in FIG. 14A, interactions 1439a-c are shown to the first user in particular areas of the user's view area. In FIG. 14B, the interaction 1439a is provided in a different location when some or all of the previous location of the interaction 1439a from FIG. 14A is out of view (e.g., as the first user's view area changes). In FIG. 140, the interaction 1439a is no longer shown (e.g., because the portion of the physical object 1030 to which it applied is out of view), and only part of the interaction 1439c is shown since the other part is out of view. The size of the interaction 1439b is larger in FIG. 140 compared to FIG. 14A and FIG. 14B because the first user is closer to the physical object 1030, and the interaction 1439b is scaled based on the size of the physical object 1030 in view.

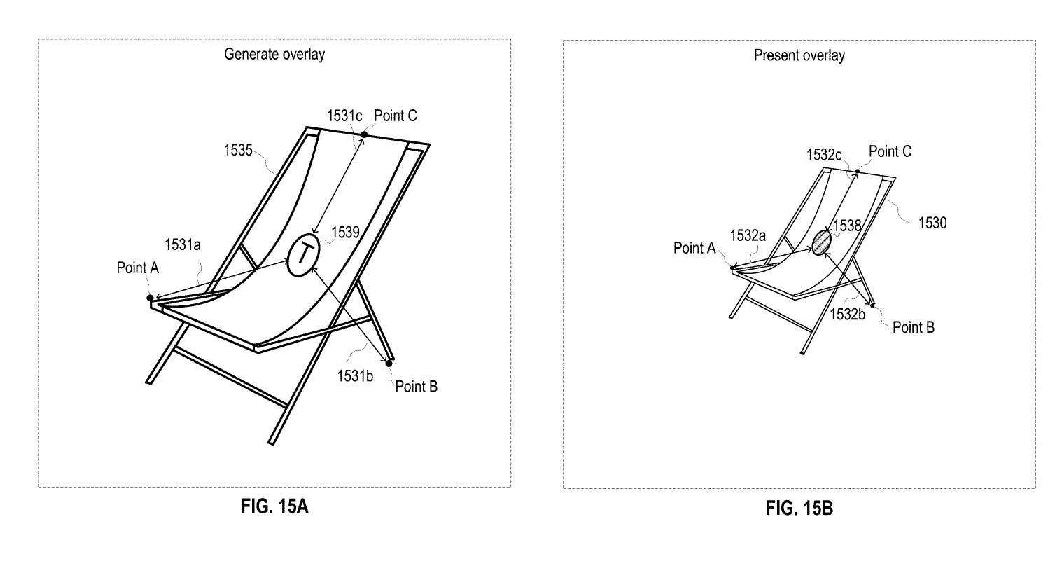

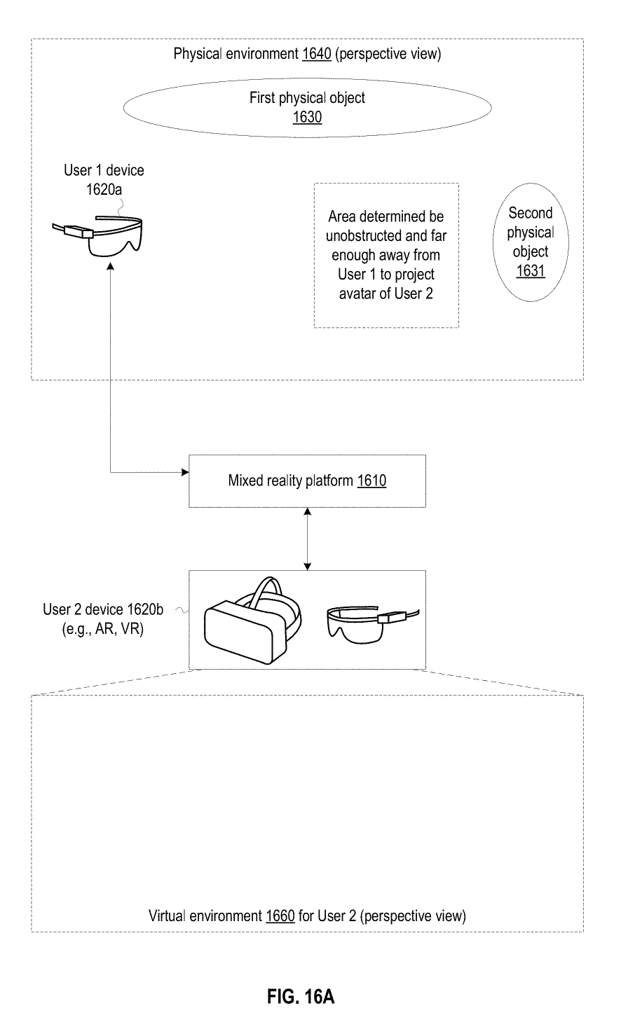

FIG. 15A and FIG. 15B are graphical representations of an embodiment of a method for determining where to display an overlay. In FIG. 15A, an overlay 1539 is generated, and its position relative to Points A-C of a virtual object 1535 are determined (e.g., using distances 1531a-c between the overlay and each of Points A-C, respectively). In FIG. 15B, the location of Points A-C are estimated on an image of a physical object 1530, distances 1532a-c from the points A-C, respectively, are determined, and an intersection area 1538 is determined where the distances 1532a-c from the points A-C intersect. A scaled version of the overlay 1539 is projected into the intersection area 1538. The distances 1532a-c from the points A-C may be determined in different ways (e.g., by scaling distances 1531a-c by a scale factor determined for the image size of the physical object 1530 relative to the size of the virtual object 1535, where the scale factor could be determined using a ratio of relative distances between pairs of points A, B or C for the virtual object 1535 and corresponding pairs of points A, B or C for the physical object 1530). Other approaches can be used to place the overlay 1539 over the physical object 1530.

Determining where to Display an Avatar in a Physical Environment

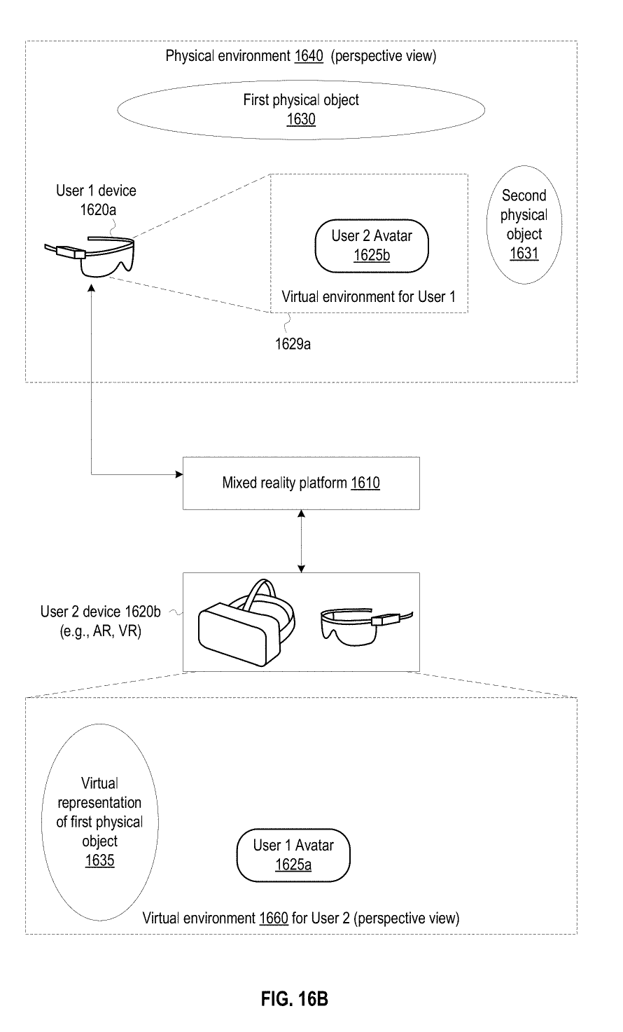

FIG. 16A and FIG. 16B are a functional block diagrams of embodiments of a system for determining where to display an avatar in a physical environment that is in view of an AR device.

The system in FIG. 16A includes a mixed reality platform 1610, a first user device 1620 (e.g., an AR device) operated by a first user in a physical environment 1640 that contains a first physical object 1630 and a second physical object 1631, and a second user device 1620b (e.g., an AR or VR device) that displays a virtual environment 1660 to a second user. An area determined be unobstructed and far enough away from the first device 1620a to project a desired avatar of the second user into the physical environment 1640 is also shown in FIG. 16A.

In FIG. 16B, a virtual environment 1629a is projected into the physical environment 1640 by the first user device 1620a. The first user device 1620a projects an avatar 1625b of the second user in the virtual environment 1629a. In FIG. 16B, a virtual representation (“virtual object”) 1635 of the first physical object 1630, and an avatar 1625a of the first user are projected into a virtual environment 1660 displayed by the second device 1620b. The relative positioning of the virtual object 1635 and the avatar 1625a from the pose of the second user may be determined by (e.g., mapped to) the relative geospatial positioning of the first physical object 1630 and the pose of the first user from the position of the avatar 1625b in a geospatial mapping of the physical environment. Any geospatial relative position of any object, user or avatar can be determined from a position of another object, user or avatar, and used to position the object, user or avatar in the virtual environment 1629a or the virtual environment 1660.

The virtual object 1635 need not be displayed in the virtual environment 1660. Also, the position of the avatar 1625a relative to the pose of the second user in the virtual environment 1660 need not be based on the position of the pose of the first user relative to the avatar 1625b in the virtual environment 1640.

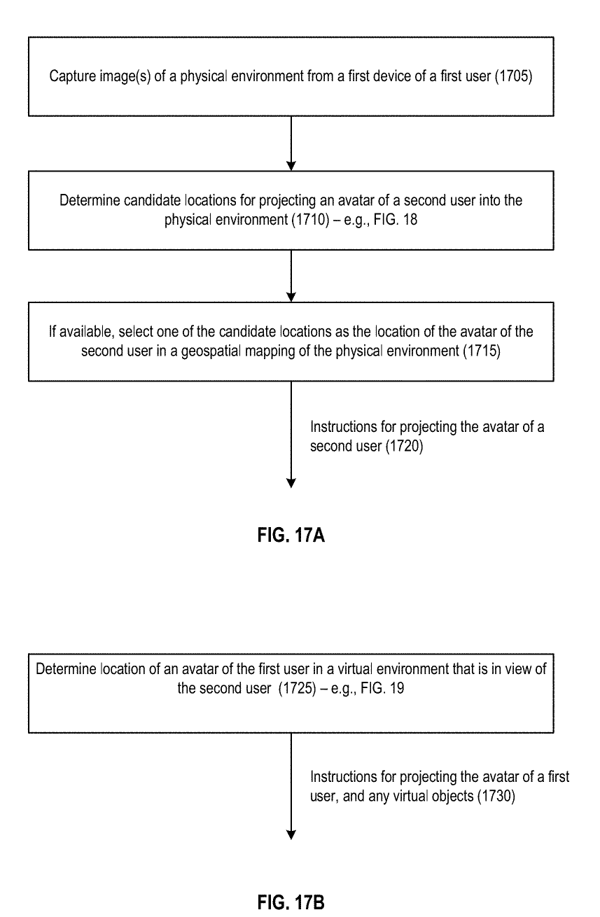

FIG. 17A through FIG. 19 are flowcharts of embodiments of a method for determining where to display an avatar in a physical environment that is in view of an AR device.

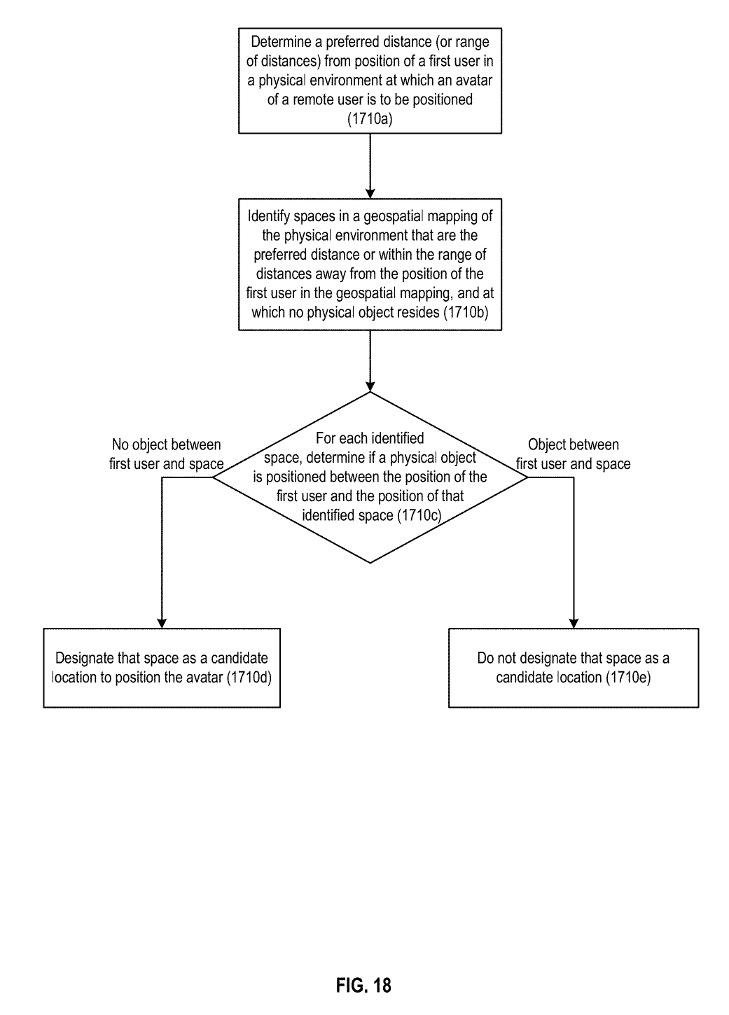

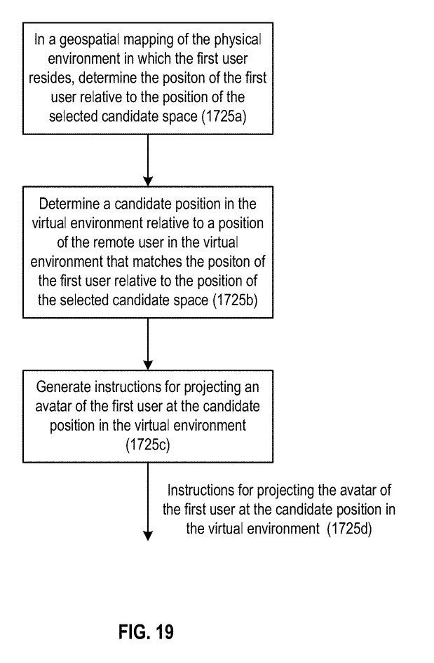

FIG. 17A and FIG. 17B provide processes for determining where to project an avatar of a remote user into a physical environment using a virtual environment that displays the avatar of the remote user to an AR user, and for determining where to display an avatar of the AR user in a virtual environment seen by the remote user. As shown in FIG. 17A, image(s) are captured from a first AR device (e.g., the device 1620a) operated by a first user (1705). Such images may be used to determine a geospatial mapping of a physical environment (e.g., the physical environment 1640) in which the first user resides. Candidate locations for projecting an avatar of a second user into the physical environment are determined (1710). One embodiment of step 1710 is depicted in the process flow of FIG. 18, which is described later. If available, one of the candidate locations is selected as the location of the avatar of the second user in a geospatial mapping of the physical environment (1715). Instructions for projecting the avatar of the second user to appear at the selected candidate location are provided to the first device (1720). In FIG. 17B, a location of an avatar of the first user in a virtual environment that is in view of the second user is determined. One embodiment of step 1725 is depicted in the process flow of FIG. 19, which is described later. Instructions for projecting the avatar of the first user, and any virtual objects are provided to the second device (1730).

A process for determining candidate locations for projecting an avatar of a remote user into a physical environment that is in view of an AR user is depicted in FIG. 18. A preferred distance from a position of an AR user in a geospatial mapping of a physical environment for positioning an avatar of a remote user is determined (1710a). The preferred distance or range of distances may be selected so the avatar is presented at a particular size at a distance that is at least a minimum distance away from the AR user. The preferred distance or range of distances can be preset, predetermined, or otherwise based on user preferences. Spaces large enough to position the avatar in a geospatial mapping of the physical environment that are the preferred distance or within the range of distances away from the position of the first user in the geospatial mapping, and at which no physical object resides, are identified (1710b). For each identified space, a determination is made as to whether an obstructing physical object is positioned between the position of the first user and the position of that identified space (1710c). If no obstructing object is determined to reside between the first user and a space, that space is designed as a candidate location to position the avatar (1710d) of the remote, or second user. If an obstructing object is determined to reside between the first user and a given space, that space is not designated as a candidate location (1710e).

A process for determining candidate locations for positioning an avatar of an AR user (e.g., the first user) into a virtual environment that is in view of another second or remote user is depicted in FIG. 19. In a geospatial mapping of the physical environment in which the first user resides, the position of the first user relative to the position of the selected candidate location is determined (1725a). A candidate position in the virtual environment relative to a position of the remote user in the virtual environment that matches the position of the first user relative to the position of the selected candidate location is determined (1725b). Instructions for projecting an avatar of the first user at the candidate position in the virtual environment are generated (1725c) and transmitted to a user device of the remote user (1725d) so the user device of the remote user displays the avatar of the first user at the candidate position in the virtual environment. Orientation of the first user in the geospatial mapping of the physical environment relative to the position of the selected candidate space may also be determined and used to orient the avatar relative to the position of the remote user in the virtual environment.

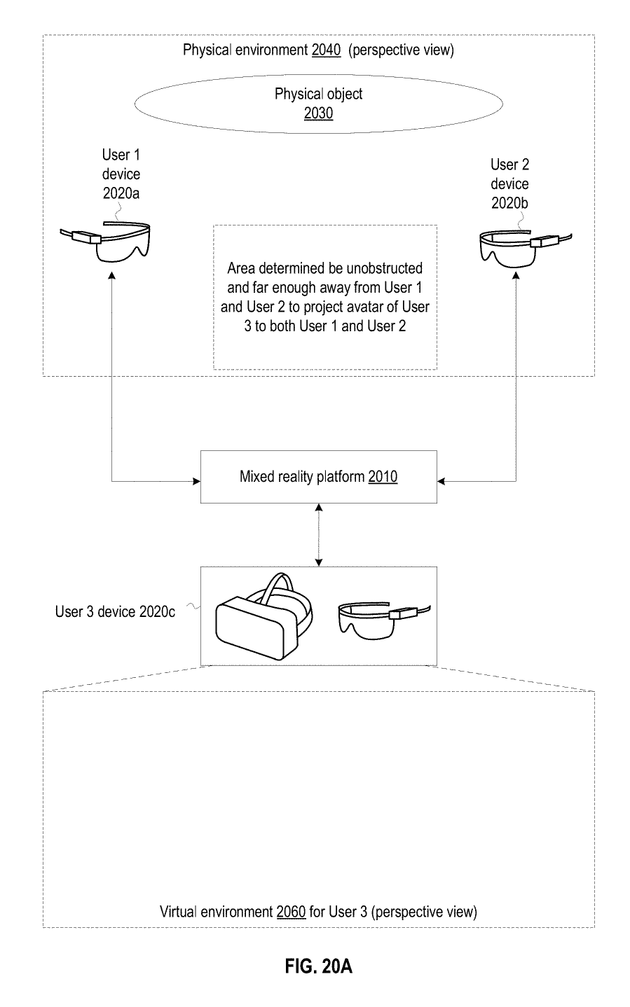

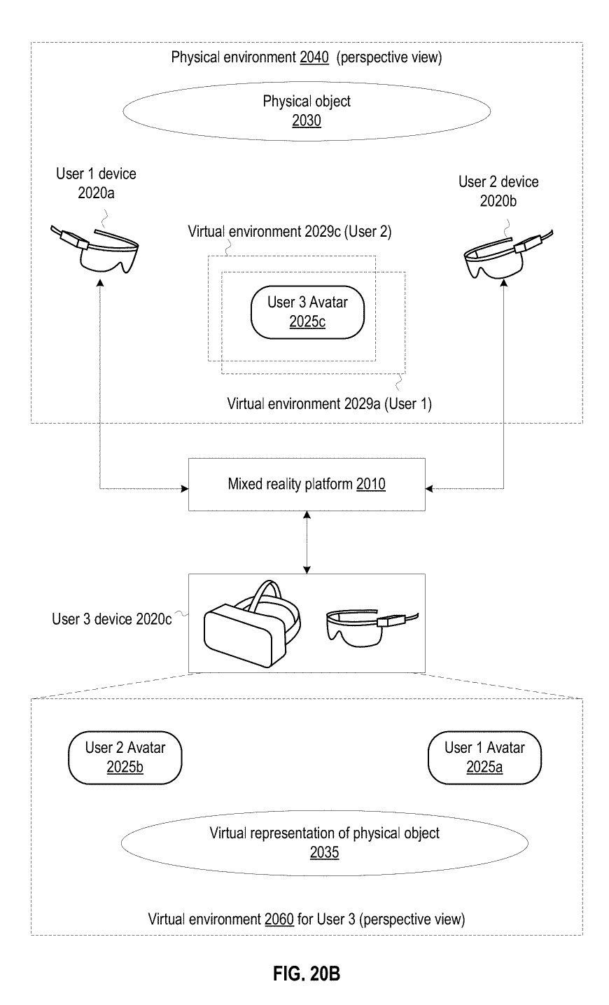

FIG. 20A and FIG. 20B are a functional block diagrams of embodiments of a system for determining where to position an avatar of a remote user in a physical environment for display in virtual environments in view of two or more AR devices.

In FIG. 20A, a first user device 2020a operated by a first user, a second user device 2020b operated by a second user, and a physical object 2030 are located in a physical environment 2040. A third user device 2020a operated by a third user is not located in the physical environment 2040. An area determined to be unobstructed and far enough away from the first device 2020a and the second device 2020b to project an avatar of the third user into the physical environment 2040 is also shown in FIG. 20A.

In FIG. 20B, a first virtual environment 2029a is projected into the physical environment 2040 by the first user device 2020a, and a second virtual environment 2029b is projected into the physical environment 2040 by the second user device 2020a. The first user device 2020a projects an avatar 2025c of the third user in the first virtual environment 2029a from the point of view of the first user, and the second user device 2020b projects the avatar 2025c of the third user in the second virtual environment 2029b from the point of view of the second user. In FIG. 20B, a virtual representation (“virtual object”) 2035 of the physical object 2030, an avatar 2025a of the first user, and an avatar 2025b are projected into a virtual environment 2060 displayed by the third device 2020c. The relative positioning of the virtual object 2035, the avatar 2025a and the avatar 2025b from the pose of the third user may be determined by (e.g., mapped to) the relative geospatial positioning of the physical object 2030, the position of the first user, and the position of the second user from the position of the avatar 2025c in a geospatial mapping of the physical environment. Any geospatial relative position of any object, user or avatar can be determined from a position of another object, user or avatar, and used to position the object, user or avatar in the virtual environment 2029a, the virtual environment 2029b, or the virtual environment 2060.

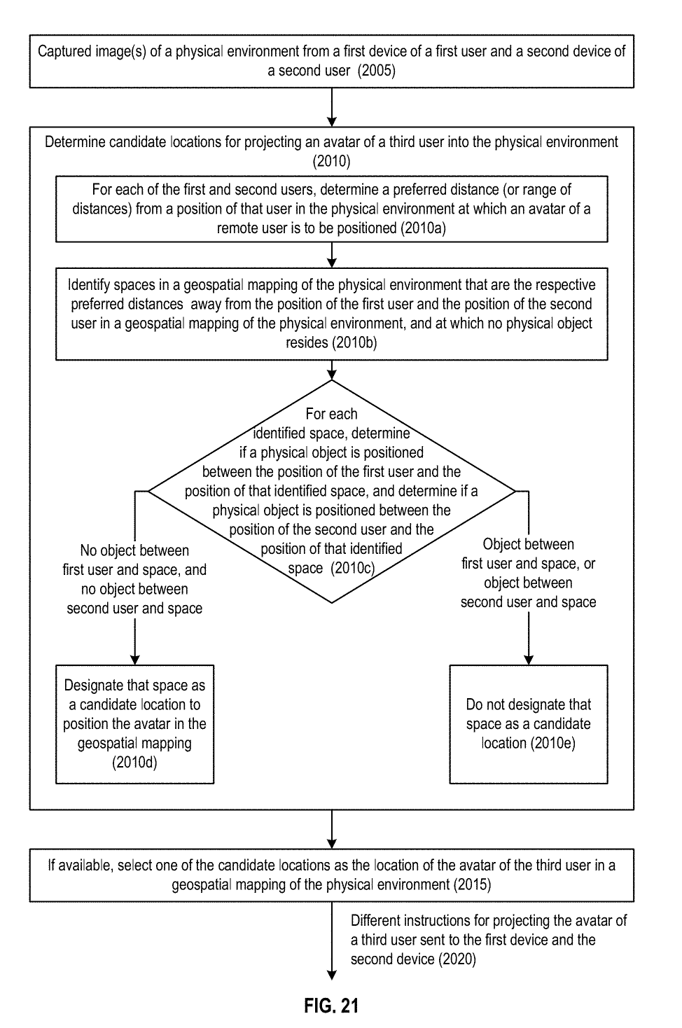

FIG. 21 is a flowchart of another embodiment of a process for determining where to display an avatar relative to positions of two or more AR users in a physical environment. As shown in FIG. 21, image(s) are captured from a first AR device (e.g., the device 1620a) operated by a first user and from a second AR device (e.g., the device 1620b) operated by a second user (2005). Such images may be used to determine a geospatial mapping of a physical environment (e.g., the physical environment 1640) in which the first user and the second user reside. Candidate locations for projecting an avatar of a third user into the physical environment are determined (2010). If available, one of the candidate locations is selected as the location of the avatar of the third user in a geospatial mapping of the physical environment (2015). Different instructions for projecting the avatar of the third user to appear at the selected candidate location are provided to the first device and the second device (2020).

One embodiment of step 2010 is depicted in FIG. 21 as sub-steps 2010a-f. For each of the first and second users, a preferred distance (or range of distances) from a position of that user in the physical environment at which an avatar of a remote user can be positioned is determined (2010a). The preferred distance or range of distances for the first user may be the same or different than the preferred distance or range of distances for the second user. Spaces in a geospatial mapping of the physical environment that are the respective preferred distances away from the position of the first user and the position of the second user in a geospatial mapping of the physical environment, and at which no physical object resides, are identified (2010b). For each identified space, determinations are made as to whether an obstructing physical object is positioned between the position of the first user and the position of that identified space, and whether an obstructing physical object is positioned between the position of the second user and the position of that identified space (2010c). If no obstructing object is determined to reside between the first user and a space, and if no obstructing object is determined to reside between the second user and the space, that space is designated as a candidate location to position the avatar (2010d). If an obstructing object is determined to reside between the first user and a space, or if an obstructing object is determined to reside between the second user and the space, that space is not designated as a candidate location (2010e).

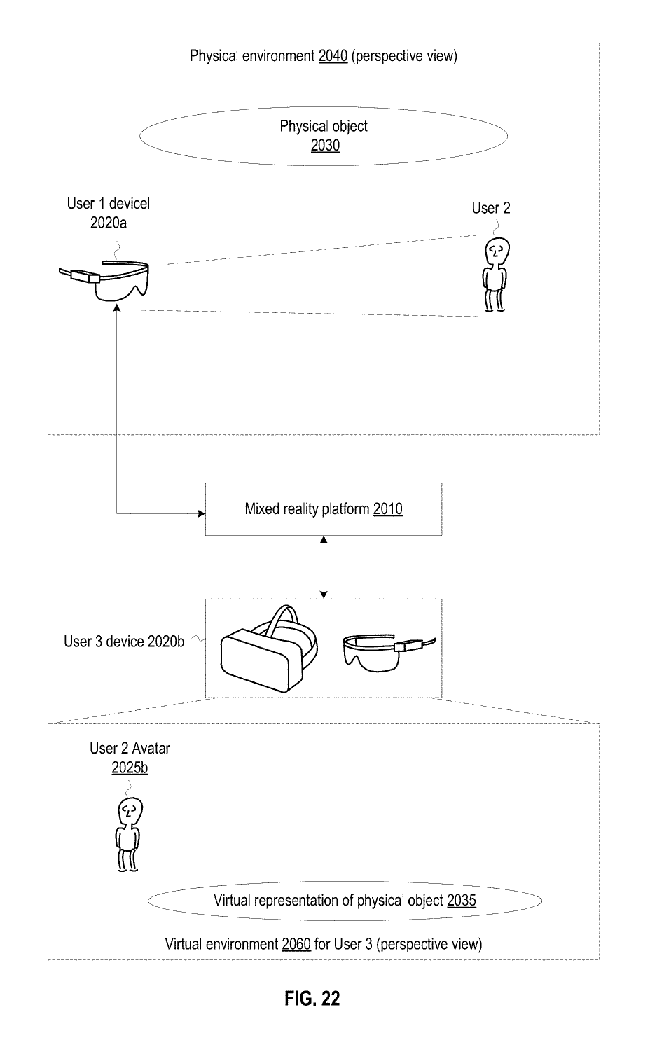

FIG. 22 is a functional block diagram of an embodiment of a system for generating an avatar that represents an AR user. The process shown in FIG. 22 can be similar to the process depicted in FIG. 21A and FIG. 21B. As shown, a device 2020a of the first user scans the second user. Alternatively, another camera could be used to scan the second user. The scanned images of the second user are used to generate an avatar of the second user. Additional scans are made to record movement of the second user, which are used to generate movements for the avatar of the second user. The avatar of the second user, and the movements of the avatar are displayed in the virtual environment 2060 to the third user.

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120 and other similar embodiments) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment. Patent Body Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The accompanying claims and their equivalents are intended to cover such forms or modifications as would fall within the scope of the disclosure. For instance, the example apparatuses, methods, and systems disclosed herein may be applied to AR and/or VR devices. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure.

What is claimed is:

1. A method for displaying an augmented reality environment, the method comprising:
generating, at a server, a geospatial map of a physical environment indicating a relative position of the one or more physical objects to a position of a first device of a first user;
storing virtual representations of the physical environment and the one or more physical objects to a memory;
determining one or more candidate locations within the physical environment for projecting an avatar of a second user based on the geospatial map of the physical environment; and
causing the first device to display the avatar of the second user at a selected candidate location of the one or more candidate locations.

2. The method of claim 1 further comprising receiving, at the server, the one or more images of the physical environment from the first device of the first user, wherein the geospatial map is based on the one or more images.

3. The method of claim 1, wherein determining the one or more candidate locations further comprises:
determining one or more spaces disposed a preferred distance from a position of the first device within the physical environment; and
identifying the one or more candidate locations from among the one or more spaces in which no physical object resides.

4. The method of claim 3, wherein the preferred distance comprises a range of distances.

5. The method of claim 3, further comprising:
determining whether an area between the position of the first device and a first space of the one or more spaces contains any physical objects;
if no physical object is between the position of the first device and the first space, designating the first space as a first candidate location of the one or more candidate locations;
if a physical object is disposed between the first device and the first space, refraining from designating the first space as the first candidate location of the one or more candidate locations.

6. The method of claim 1 further comprising:
determining a location of an avatar of the first user in a virtual environment that is in view of the second user; and
causing the second device to project the avatar of the first user in the virtual environment based on the determining.

7. The method of claim 6, further comprising:
determining the position of the first device relative to the position of the selected candidate location based on the geospatial mapping.
determining a candidate position in the virtual environment relative to a position of a second device of the second user in the virtual environment that matches the position of the first user relative to the position of the selected candidate location;
causing the second device to project an avatar of the first user at the candidate position in the virtual environment.

8. The method of claim 7, wherein the second device is remote from the first device.

9. The method of claim 1 further comprising orienting the avatar of the first user relative to the position of the second user in the virtual environment based on an orientation of the first user in the geospatial mapping of the physical environment relative to the position of the selected candidate space.

10. A non-transitory computer-readable medium comprising instructions for displaying an augmented reality environment that when executed by one or more processors cause the one or more processors to:
generate a geospatial map of a physical environment indicating a relative position of the one or more physical objects to a position of a first device of a first user;
store virtual representations of the physical environment and the one or more physical objects to a memory;
determine one or more candidate locations within the physical environment for projecting an avatar of a second user based on the geospatial map of the physical environment; and
cause the first device to display the avatar of the second user at a selected candidate location of the one or more candidate locations.

11. The non-transitory computer-readable medium of claim 10 further comprising instructions that cause the one or more processors to receive, the one or more images of the physical environment from the first device of the first user, wherein the geospatial map is based on the one or more images.

12. The non-transitory computer-readable medium of claim 10 further comprising instructions that cause the one or more processors to:
determining one or more spaces disposed a preferred distance from a position of the first device within the physical environment; and
identifying the one or more candidate locations from among the one or more spaces in which no physical object resides.

13. The method of claim 12, wherein the preferred distance comprises a range of distances.

14. The method of claim 12, further comprising:
determining whether an area between the position of the first device and a first space of the one or more spaces contains any physical objects;
if no physical object is between the position of the first device and the first space, designating the first space as a first candidate location of the one or more candidate locations;
if a physical object is disposed between the first device and the first space, refraining from designating the first space as the first candidate location of the one or more candidate locations.

15. The method of claim 9 further comprising:
determining a location of an avatar of the first user in a virtual environment that is in view of the second user; and
causing the second device to project the avatar of the first user in the virtual environment based on the determining.

16. The method of claim 15, further comprising:
determining the position of the first device relative to the position of the selected candidate location based on the geospatial mapping.
determining a candidate position in the virtual environment relative to a position of a second device of the second user in the virtual environment that matches the position of the first user relative to the position of the selected candidate location;
causing the second device to project an avatar of the first user at the candidate position in the virtual environment.

17. The method of claim 16, wherein the second device is remote from the first device.

18. The method of claim 10 further comprising orienting the avatar of the first user relative to the position of the second user in the virtual environment based on an orientation of the first user in the geospatial mapping of the physical environment relative to the position of the selected candidate space.
